(19) United States
(12) Patent Application Publication
(10) Pub. No.: US 2005/0169474 A1
(43) Pub. Date: Aug. 4, 2005

(54) Distribution system

(75) Inventor: Masaharu Kako, Osaka (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/089,142

(22) Filed: Mar. 25, 2005

Related U.S. Application Data
(63) Continuation of application No. PCT/JP03/01932, filed on Feb. 21, 2003.

(51) Int. Cl. H04N 7/167

(52) U.S. Cl. 380/239; 380/278; 713/163

(57) ABSTRACT

A distribution system comprising an adding unit adding an electronic sign to a code request by using first key data corresponding to second key data possessed by a managing device to which a code request is sent; a transmitting unit transmitting the code request which the electronic sign generated by the adding unit; a receiving unit receiving encrypted data to be multicast and a code response transmitted in response to the code request; an acquiring unit decrypting decrypting code included in the code response received by the receiving unit and encrypted by third key data, by using fourth key data corresponding to the third key data acquiring the decrypted decrypting data; and a decrypting unit decrypting encrypted data received by the receiving unit by using decrypting data acquire by the acquiring unit and delivering the decrypted data to output unit.

### BACKGROUND OF THE INVENTION

The present invention relates to a system for delivering a content by transmitting and receiving encrypted data through a network.

A system for executing a pay broadcast adopt a measure for preventing illegal viewing of a user. Conventionally, a station for executing the pay broadcast (hereafter, referred to as pay broadcast station) instructs a viewer to buy a receiving apparatus dedicated to each station. The viewer can view the pay broadcast of each station, by using the bought receiving apparatus. For example, data scrambled with a scrambling code is transmitted by the station, and the data scrambled with the scrambling code can be decoded only by a scramble key installed in the receiving apparatus, and the viewing becomes possible. The viewer makes a contract about a payment of a viewing fee and the like, with the station for executing the pay broadcast when buying the receiving apparatus. In this way, the illegal viewing of the user was prevented.

However, this system had several problems. Firstly, since the user needed to buy the receiving apparatus before starting the viewing, an initial installation cost was enormous. This enormous initial installation cost caused the user to hesitate to start the viewing of the pay broadcast.

Also, since the conventional receiving apparatus was the apparatus dedicated to each station, the user needed to buy the receiving apparatus for each broadcast station. That is, the user, when viewing a broadcast program of a broad cast station (another broadcast station) different from the station having a contract with the user himself, needed to buy a new receiving apparatus. This caused the user hesitate to start the viewing of the pay broadcast of the different broadcast station.

Also, when the receiving apparatus is exchanged, the exchange needs to be performed for all of the viewers. Thus, enormous labors and costs are required. For this reason, the same receiving system has been operated for a long time without any change. Hence, in association with the elapse of the long operation period, there was a problem that an unauthenticated viewer could easily and illegally obtain the scramble key.

As a solution to the foregoing problem, there is a system for executing the pay broadcast on IP (Internet Protocol). For example, there is a system for executing the pay broadcast through the Internet. In the system, a dedicated virtual communication path is set by unicast, and a typical encrypting technique such as IPSEC (IP Security) is used to prevent the illegal viewing. Thus, the user does not need to buy the receiving apparatus dedicated to each station, and the viewing is possible by using a personal computer connected to a network. Also, the data on the scramble key and the like can be easily changed, thereby making it difficult for the unauthenticated viewer to obtain the key.

Also, as the conventional techniques, there are the following. Firstly, there is a technique in which a broadcast company broadcasts the information on an access point of a particular free provider that does not require a subscription contract and an authentication procedure specified by the broadcast company through a data broadcast, together with a normal broadcast, and at the time of selecting a two-way communication, irrespective of whether or not the viewer signs up with the provider, a communication line is connected to the free provider, thereby accessing the Internet (refer to Patent Document 1).

Also, secondly, there is a system including a broadcast station, a database, a receiving apparatus, a data communication apparatus and a user terminal apparatus, in which a secret key method, a public key method and a digital signature method are used as an encryption key method, and those keys are supplied by the broadcast while they are encoded or not encoded (refer to Patent Document 2).

[Patent Document 1]

Japanese Patent Application Laid-Open Publication No. 2000-13524.

[Patent Document 2]

Japanese Patent Application Laid-Open Publication No. 8-288940.

### BRIEF SUMMARY OF THE INVENTION

However, the conventional system that carries out the pay broadcast on the IP has the following problem. Since the pay broadcast on the IP used the unicast in order to prevent the illegal viewing, the processes in a server of the broadcast station and a relay apparatus on a route were increased. Thus, depending on the abilities of the server of the broadcast station and the relay apparatus on the route, the number of viewers simultaneously accessing there was limited.

The present invention has an object to provide a system, which solves the above-mentioned problems, and prevents illegal viewing and simultaneously reduces a processing load on the server of the broadcast station and the relay apparatus on the route.

[First Aspect]

In order to solve the above-mentioned problems, the present invention has the following configuration. A first aspect of the present invention provides a distribution system including a management apparatus and a receiving apparatus.

According to the first aspect, the management apparatus includes: a receiving unit receiving a code request including an electronic sign generated in accordance with a first key data; an authentication unit authenticating a transmission source of the code request by using a second key data corresponding to the first key data and the electronic sign; a reply unit, when the authentication unit authenticates the transmission source, transmitting a code response which included at least a decryption code and is encrypted in accordance with a third key data; an encryption unit encrypting data of a content to be multicasted, by using an encryption code corresponding to the decryption code; and distribution unit multicasting the data encrypted by the encryption unit.

According to the first aspect, the receiving apparatus includes: an addition unit adding the electronic sign to the code request by using the first key data; a transmission unit transmitting the code request including the electronic sign generated by the addition unit; a receiving unit receiving an encrypted data which is multicasted by the management apparatus and the code response which is transmitted by the management apparatus; an obtainment unit decrypting and obtaining the decryption code included in the code response received by the receiving unit, by using a fourth key data corresponding to the third key data; and a decryption unit decrypting the encrypted data received by the receiving unit by using the decryption code obtained by the obtainment unit, and passing a decryption data to an output unit.

The first key data and the second key data may have any configuration if an electronic sign generated in accordance with the first key data can be authenticated by the second key data. For example, the first key data and the second key data may be configured by using a public key and a secret key which are generated in accordance with a public key method. Also, for example, the first key data and the second key data may be configured by using the same secret key. However, when the second key data is configured by using the public key, a user of an apparatus (for example, a receiving apparatus) serving as a transmission source of a code request can confirm a content of the transmitted code request by decrypting the code request using the second key data. In the case where the second key data is configured by using the public key, there is no influence on an authenticating operation with the authentication unit, even if the second key data is published to the user as mentioned above.

Also, the first key data and the fourth key data may be configured by using the same key data. In this case, the second key data and the third key data are configured by using the same key data. With this configuration, the number of key data used can be reduced. Thus, the management of the key data becomes easy.

Also, the first key data and the fourth key data may be able to be referred to only by addition unit and the obtainment unit. With this configuration, it is possible to prevent the user of the receiving apparatus from obtaining the first key data and the fourth key data and prevent this key data from being illegally used.

According to the first aspect of the present invention, the addition unit of the receiving apparatus uses the first key data and adds the electronic sign to the code request, and transmission unit transmits this code request to a management apparatus.

When receiving unit of the management apparatus receives this code request, authentication unit uses the electronic sign and second key data which are included in this code request and authenticates the transmission source (for example, the receiving apparatus) of the code request. If the transmission source is authenticated, reply unit sends a code response including a decryption code encrypted by the third key data to the authenticated transmission source. At this time, the code response may be configured such that the entire code response is encrypted by the third key data.

When the receiving unit of the receiving apparatus receives this code response, the obtainment unit obtains the decryption code included in this code response by using the fourth key data.

Encryption unit of the management apparatus uses an encryption code and encrypts data of a content which is multicasted. This encryption code corresponds to the decryption code included in the code response sent by the reply unit. That is, the data encrypted by this encryption code can be decrypted by this decryption code. Distribution unit multicasts the data encrypted by the encryption unit.

When the receiving unit of the receiving apparatus receives this data, the decryption unit decrypts this data. At this time, the decryption unit uses the decryption code obtained by the obtainment unit and decrypts the received data. Then, the decryption unit passes the decrypted data (plaintext) to output unit.

According to the first aspect of the present invention, the data to be multicasted by the management apparatus, namely, the data to be delivered is decrypted by the decryption code. Then, the decryption code for decrypting this data is transmitted to the receiving apparatus authenticated by the first key data and the second key data. Moreover, this decryption code is transmitted and received by using the encrypted communication based on the third key data and the fourth key data. Thus, unless the first key data and the fourth key data are leaked, the illegal obtainment of the delivered data can be prevented. Thus, the illegal obtainment of the delivered data can be prevented without any transmission from the management apparatus to the receiving apparatus through the unicast transmission. Hence, for example, if the delivered data is the content data of image data or the like, according to the first aspect of the present invention, the illegal viewing can be prevented.

Also, the delivered data is transmitted through the multicast communication. Thus, unlike the conventional transmission by unicast, the processing loads on the apparatus (management apparatus) serving as the data transmission source and the relay apparatus on the route can be reduced.

Also, the management apparatus according to the first aspect of the present invention may be configured so as to further include: a key generation unit newly generating the first key data and the second key data; and a key transmission unit transmitting the first key data generated by the key generation unit to the receiving apparatus. In this case, the authentication unit carries out the authentication by using the newly generated second key data after the key generation unit newly generates the second key data. Also, in this case, the addition unit of the receiving apparatus carries out the addition of the electronic sign by using the received new first key data, after the receiving of the new first key data from the management apparatus. With this configuration, it is possible to update the first key data and the second key data, and prevent the leakage of the first key data and the second key data.

Similarly, the first aspect of the present invention may be configured so as to update the third key data and the fourth key data. In this case, the key generation unit further generates the third key data and the fourth key data. The key transmission unit transmits the fourth key data generated by the key generation unit to the receiving apparatus. The authentication unit carries out the authentication by using the newly generated third key data, after the key generation unit newly generates the third key data. Then, the obtainment unit of the receiving apparatus obtains the decryption code by using the received new fourth key data, after the receiving of the new fourth key data from the management apparatus.

Further, according to the first aspect of the present invention, the addition unit of the receiving apparatus may further add an identification data to identify a user of its own apparatus to the code request. As an example of the identification data, there are a number of a credit card of a user, an electronic sign based on a key data uniquely used by a user, and the like. A manager, an operator and the like of the management apparatus can identify and authenticate the user of the receiving apparatus, by using this identification data. Moreover, a download fee, a viewing fee, and the like of the delivered data can be collected from the user by using this identification data.

Further, according to the first aspect of the present invention, the addition unit, the obtainment unit, and the decryption unit may be implemented on the receiving apparatus when a program is executed by the receiving apparatus. The management apparatus according to the first aspect of the present invention may further include a publication unit publishing the program in a form of being downloadable by the receiving apparatus through a network.

With this configuration, the user who desires the obtainment (viewing) of the delivered data can implement the addition unit, the obtainment unit and the decryption unit on the receiving apparatus, by downloading a program from the management apparatus. Thus, the user can easily obtain the delivered data without any necessity of buying a new dedicated apparatus in order to obtain the delivered data. Also, the publication unit may be configured so as to publish the first key data and the fourth key data in a form of being downloadable by the receiving apparatus. In this case, the first key data and the fourth key data may be configured so as to be included in the aforementioned program.

[Second Aspect]

A second aspect of the present invention provides a distribution system including a management apparatus, a distribution apparatus, and a receiving apparatus. An according to the second aspect of the present invention, the unit included in the management apparatus according to the first aspect of the present invention are separately held by the management apparatus and the distribution apparatus.

That is, according to the second aspect of the present invention, the management apparatus includes: a receiving unit receiving a code request including an electronic sign generated in accordance with a first key data; an authentication unit for authenticating a transmission source of the code request by using a second key data corresponding to the first key data and the electronic sign; and a reply unit for, when the authentication unit authenticates the transmission source, transmitting a code response which includes at least a decryption code and is encrypted in accordance with a third key data.

Further, according to the second aspect of the present invention, the distribution apparatus includes: an encryption unit encrypting data of a content to be multicasted, by using an encryption code corresponding to the decryption code; and a distribution unit multicasting the data encrypted by the encryption unit.

Further, according to the second aspect of the present invention, the receiving apparatus includes: an addition unit adding the electronic sign to the code request by using the first key data; a transmission unit transmitting the code request including the electronic sign generated by the addition unit; a receiving unit receiving an encrypted data which is multicasted by the distribution apparatus and the code response which is transmitted by the management apparatus; an obtainment unit decrypting and obtaining the decryption code included in the code response received by the receiving unit, by using a fourth key data corresponding to the third key data; and a decryption unit decrypting the encrypted data received by the receiving unit by using the decryption code obtained by the obtainment unit, and passing a decrypted data to an output unit.

Further, according to the second aspect of the present invention, the addition unit, the obtainment unit, and the decryption unit may be implemented on the receiving apparatus when a program is executed by the receiving apparatus. Further, the distribution system according to the second aspect of the present invention may further include a publication apparatus for publishing the program in a form of being downloadable by the receiving apparatus through a network.

With this configuration, the user who desires the obtainment (viewing) of the delivered data can implement the addition unit, the obtainment unit and the decryption unit on the receiving apparatus, by downloading the program from the publication apparatus. Thus, the user can easily obtain the delivered data without any necessity of buying the new dedicated apparatus in order to obtain the delivered data. Also, the publication apparatus may be configured so as to publish the first key data and the fourth key data in the form of being downloadable by the receiving apparatus. In this case, the first key data and the fourth key data may be configured so as to be included in the above program.

[Third Aspect]

A third aspect of the present invention provides management apparatus including: a receiving unit receiving a code request including an electronic sign generated in accordance with a first key data; an authentication unit authenticating a transmission source of the code request using a second key data corresponding to the first key data and the electronic sign; a reply unit, when the authentication unit authenticates the transmission source, transmitting a code response which includes at least a decryption code and is encrypted in accordance with a third key data; an encryption unit encrypting data of a content to be multicasted, by using an encryption code corresponding to the decryption code; and a distribution unit multicasting the data encrypted by the encryption unit.

[Fourth Aspect]

A fourth aspect of the present invention provides a receiving apparatus including: an addition unit adding an electronic sign to a code request by using a first key data corresponding to a second key data of a management apparatus which is a transmission destination of the code request; a transmission unit transmitting the code request including the electronic sign generated by the addition unit; a receiving unit receiving an encrypted data which is multicasted and the code response which is transmitted in response to the code request; an obtainment unit decrypting and obtaining the decryption code, which is included in the code response received by the receiving unit and encrypted in accordance with a third key data, by using a fourth key data corresponding to the third key data; and a decryption unit decrypting the encrypted data received by the receiving unit, by using the decryption code obtained by the obtainment unit and passing to output unit.

According to the fourth aspect of the present invention, the first key data and the fourth key data may be configured so as to be able to be referred to only by the addition unit and the obtainment unit.

[Fifth Aspect]

A fifth aspect of the present invention provides a program for controlling an information processing apparatus to execute: adding an electronic sign to a code request by using a first key data corresponding to a second key data of a management apparatus which is a transmission destination of the code request; transmitting the code request to which the electronic sign is added; receiving the code response transmitted in response to the code request; decrypting and obtaining the decryption code, which is included in the received code response and encrypted in accordance with a third key data, by using a fourth key data corresponding to the third key data; receiving the encrypted data which is multicasted; and decrypting the encrypted data which is received, by using the obtained decryption code, and passing to an output unit, wherein the first key data, the fourth key data, and the decryption code are not able to be referred to by a user of the information processing apparatus and a different programs executed by the information processing apparatus.

Further, in the program according to the fifth aspect of the present invention, the first key data and the fourth key data may be provided.

Further, in the program according to the fifth aspect of the present invention, the first key data and the fourth key data may be configured by using the same key data, and the second key data and the third key data may be configured by using the same key data.

According to the present invention, by preventing the illegal viewing of the delivered data as well as delivering through the multicast communication, it is possible to reduce the processing load on the distribution apparatus (for example, the server of the broadcast station) and the relay apparatus existing between this apparatus and the receiving apparatus.

### BRIEF DESCRIPTION OF THE DRAWINGS

FIG. 1 is a diagram showing a schema of a broadcast system according to the present invention;

FIG. 2 is a functional block diagram of a client and a local station according to a first embodiment;

FIG. 3 is a diagram showing contents of a message of a decryption code request;

FIG. 4 is a diagram showing contents of a message of a decryption code response;

FIG. 5 is a diagram showing stored contents of a key storage section;

FIG. 6 is a diagram showing decryption information;

FIG. 7 is a diagram showing publication destination information;

FIG. 8 is a diagram showing encryption information;

FIG. 9 is a diagram showing contents of encrypted data;

FIG. 10 is a flowchart showing an operation example of a decryption code obtainment section;

FIG. 11 is a flowchart showing an operation example of a decryption section;

FIG. 12 is a flowchart showing an operation example of an applet generation section;

FIG. 13 is a flowchart showing an operation example of a viewer authentication section;

FIG. 14 is a flowchart showing an operation example of an encryption section;

FIG. 15 is a diagram showing a sequence example of a receiving start process;

FIG. 16 is a diagram showing sequence example of a receiving continuation process;

FIG. 17 is a functional block diagram of a client and a local station according to a second embodiment;

FIG. 18 is a diagram showing contents of a switching client key set table;

FIG. 19 is a diagram showing contents of a switching local station key set table;

FIG. 20 is a diagram showing contents of encrypted data;

FIG. 21 is a flowchart showing an operation example of an encryption section;

FIG. 22 is a flowchart showing an operation example of an encryption section;

FIG. 23 is a flowchart showing an operation example of an encryption section;

FIG. 24 is a flowchart showing an operation example of an encryption section;

FIG. 25 is a flowchart showing an operation example of a switching key generation section;

FIG. 26 is a flowchart showing an operation example of a decryption section;

FIG. 27 is a flowchart showing an operation example of a decryption section;

FIG. 28 is a diagram showing a process with regard to a switching client key set; and

FIG. 29 is a diagram showing a process with regard to a switching local station key set.

### DETAILED DESCRIPTION OF THE INVENTION

A system and apparatus in embodiments of the present invention will be described below by using the drawings. Incidentally, the explanation of the embodiments is an exemplification, and the configuration of the present invention is not limited to the following explanation.

### First Embodiment

[System Configuration]

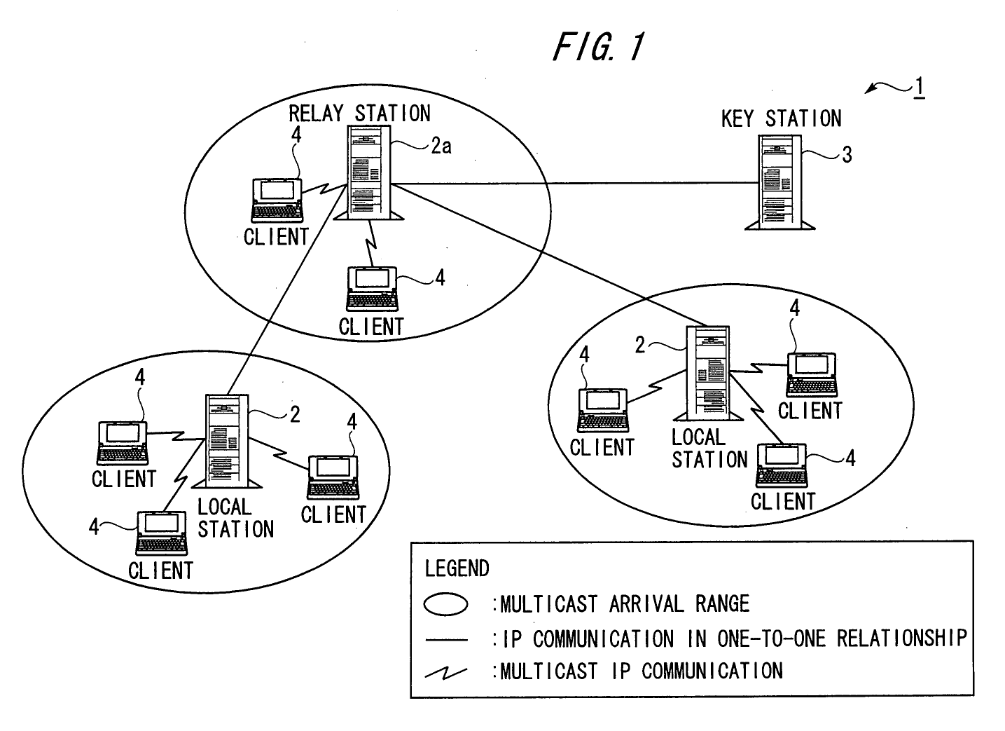

FIG. 1 is a diagram showing a schema of a broadcast system 1 according to a first embodiment of the present invention. The broadcast system 1 will be explained by using FIG. 1.

The broadcast system 1 is composed of with a relay station 2a, local stations 2, a key station 3 and a plurality of clients 4. IP communications of a one-to-one relationship are carried out between the key station 3 and the relay station 2a and between the relay station 2a and each local station 2. Also, IP communications based on multicast are carried out between the relay station 2a and the local station 2, and each client 4.

In the broadcast system 1, data of contents transmitted by the key station 3 is delivered by the relay station 2a or local station 2 to each client 4. At this time, the relay station 2a or local station 2 encrypts the data of the contents, uses the IP communication based on the multicast and delivers the data of the content. In the following explanations, the data of the content transmitted by the key station 3 is assumed to be streaming data. Actually, the data of the content transmitted by the key station 3 may be any data depending on a usage field.

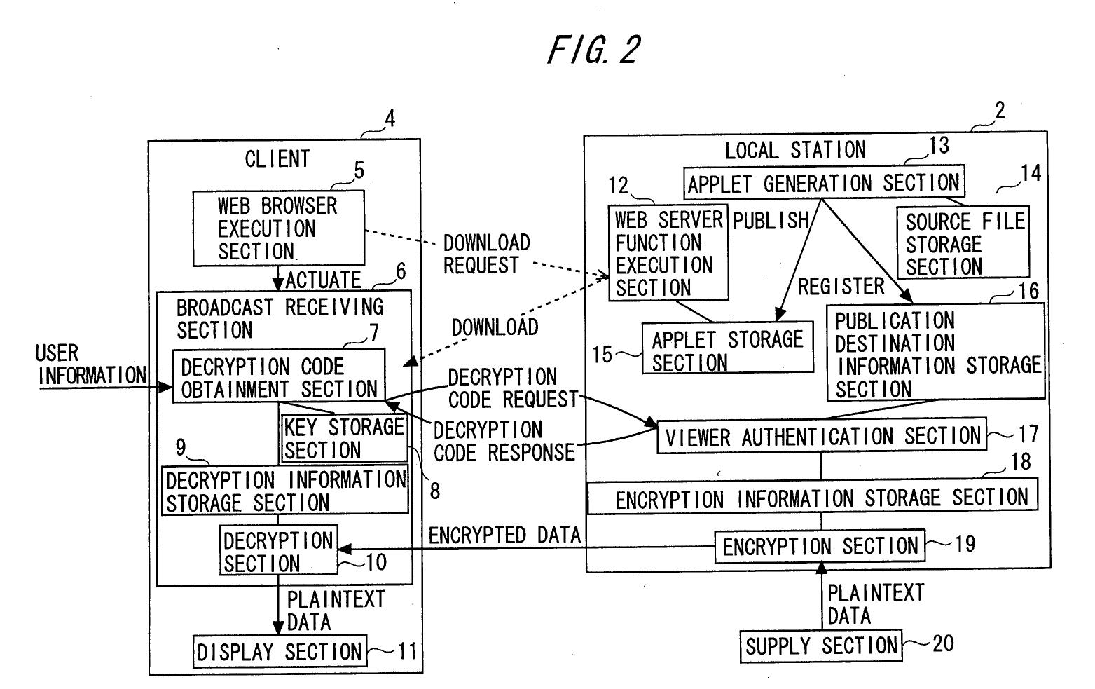

FIG. 2 is a block diagram showing configurations of the local station 2 and the client 4. The configurations of the local station 2 and the client 4 will be described below by using FIG. 2. Although, in the explanation of FIG. 2 and the subsequent explanation, the configuration of the local station 2 will be described, the relay station 2a has the similar configuration. That is, the client 4 can also obtain the data of the content by carrying out the communications similar to the communications in the following explanation, with the relay station 2a. Incidentally, the relay station 2a has a function of delivering the data of the content to the plurality of local stations 2, in addition to the configuration of the local station 2 which will be described below.

Client

At first, the configuration of the client 4 is explained. The client 4 is configured by using information processing apparatus having a communication function, such as a personal computer, a workstation, or PDA (Personal Digital Assistants). The client 4 includes a CPU connected through a bus, a main memory (RAM), and an auxiliary storage (a hard disk, a flash memory, or the like) as hardware. The client 4 functions as the apparatus including a Web browser execution section 5, a broadcast receiving section 6, and a display section 11, when various programs (OS, applications, and the like) stored in the auxiliary storage are loaded to the main memory and executed by the CPU. Also, the client 4 includes a communication apparatus (not shown). The Web browser execution section 5, the broadcast receiving section 6, and the display section 11 use the communication apparatus to communicate with the local station 2 or another apparatus through a network.

Web Browser Execution Section

The Web browser execution section 5 is attained when the program of the Web browser is executed by the CPU. The program to be executed may be a program of any Web browser, for example, Internet Explore or Netscape (registered trademarks). The Web browser execution section 5 provides the functions of the Web browser to the client 4. The user uses the Web browser execution section 5 to download a broadcast receiving applet from the local station 2.

Broadcast Receiving Section

The broadcast receiving section 6 is attained when an execution code of the broadcast receiving applet stored in the client 4 is executed by the CPU. Also, the broadcast receiving section 6 writes data to the main memory or auxiliary storage in the client 4, in order to hold the data as necessary. The broadcast receiving section 6 receives the data of the content from the local station 2 and converts the received data into data that can be displayed on the display section 11. The broadcast receiving section 6 includes a decryption code obtainment section 7, a key storage section 8, a decryption information storage section 9, and a decryption section 10, in order to carry out the foregoing processes. The respective configurations of the broadcast receiving section 6 will be described below.

Decryption Code Obtainment Section

The decryption code obtainment section 7 generates a decryption code request and transmits the generated decryption code request to the local station 2, and consequently receives a decryption code response. The decryption code obtainment section 7 decrypts the received decryption code response by using a client secret key stored in the key storage section 8. The decryption code obtainment section 7 obtains the decryption code included in the decrypted decryption code response and writes the obtained decryption code to the decryption information storage section 9.

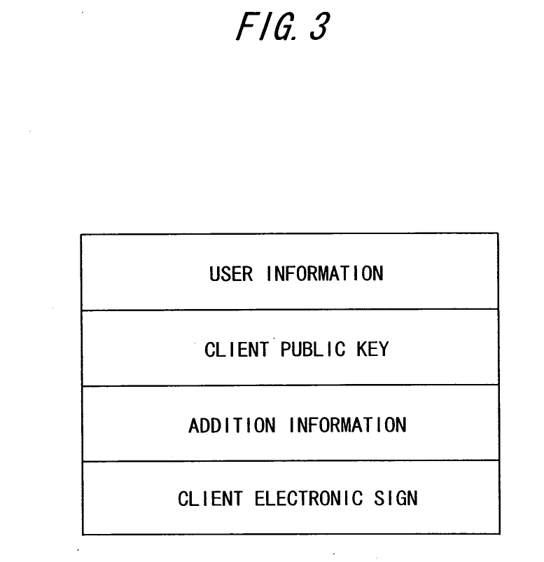

FIG. 3 is a diagram showing the configuration of the data of the decryption code request. The decryption code request includes user information, a client public key, additional information and a client electronic sign.

The user information includes information of the user of the client 4. For example, if the content delivered to the client 4 by the local station 2 is charged, credit information for collecting a viewing fee and the like are included in the user information. Also, the user information may be a matter that can authenticate the user itself, such as the electronic sign prepared by the user. Incidentally, this embodiment is assumed such that the content delivered to the client 4 from the local station 2 is charged, so the user information includes the credit information of the user. The user information is inputted by the user through an input device connected to or installed in the client 4. Also, the user information may be the data that is stored in advance in the auxiliary storage of the client 4.

The client public key is public key data, which is capsulated together with the corresponding client secret key and held in the applet, as the data of the broadcast receiving applet stored in the client 4. For this reason, the client public key can be basically read out or changed only by using the function of the broadcast receiving applet, namely, the configuration of the broadcast receiving section 6. The client secret key corresponding to the client public key is similarly capsulated and stored in the client 4. In the client public key and the client secret key, the same data is used by a plurality of users receiving the broadcast receiving applet. In other words, the plurality of users receive the broadcast receiving applet and consequently use the common client public key and client secret key.

The additional information is the data that is not related to the attainment of the broadcast system 1 according to the present invention, and it can be freely used by the matter that attains the broadcast system 1.

The client electronic sign is the electronic sign generated by using the client secret key stored in the client 4. This electronic sign is generated by the decryption code obtainment section 7.

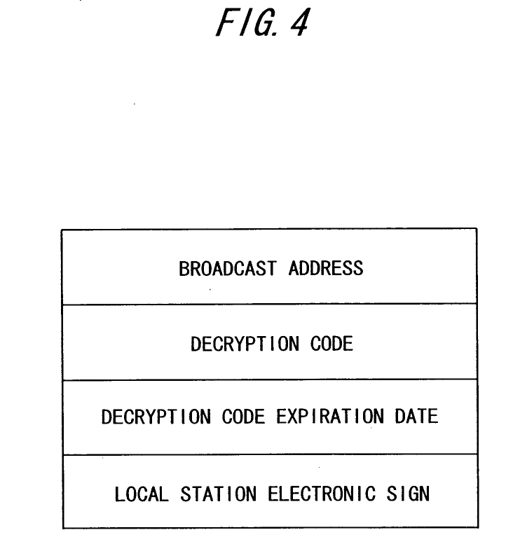

FIG. 4 is a diagram showing a configuration of the data of the decryption code response. The decryption code response includes a broadcast address, a decryption code, a decryption code expiration date, and a local station electronic sign.

The broadcast address indicates a multicast address of contents that is currently being delivered by the local station 2.

The decryption code is the data used to decrypt the data of the contents delivered from the local station 2.

The decryption code expiration date is the data corresponding to the decryption code and indicates the expiration date of the corresponding decryption code. The decryption code and its expiration date may be configured such that the plurality of them is included in one decryption code response, as necessary.

The local station electronic sign is the electronic sign generated by the local station 2. The local station electronic sign is used by the decryption code obtainment section 7 to authenticate the decryption code response. The decryption code obtainment section 7 correlates the decryption code included in the authenticated decryption code response and its expiration date and writes them to the decryption information storage section.

Key Storage Section

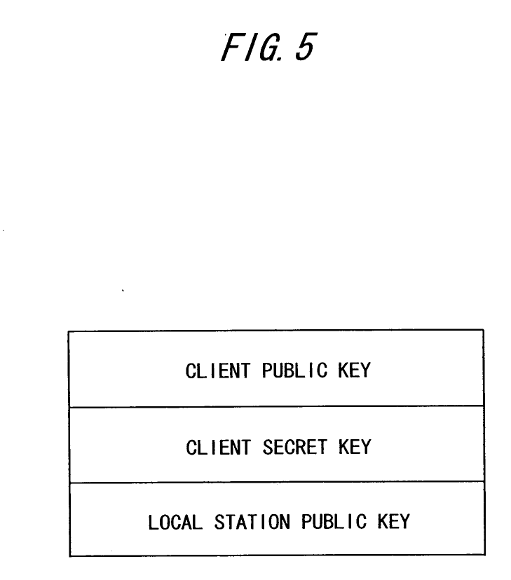

FIG. 5 is a diagram showing data stored in the key storage section 8. The key storage section 8 stores a key set of the client public key and the client secret key. Also, the key storage section 8 stores the public key (local station public key) of the local station 2. The key storage section 8 correlates and stores the key set and the local station public key which are included in one broadcast receiving applet. The data stored in the key storage section 8 is read and written by the decryption code obtainment section 7.

Decryption Information Storage Section

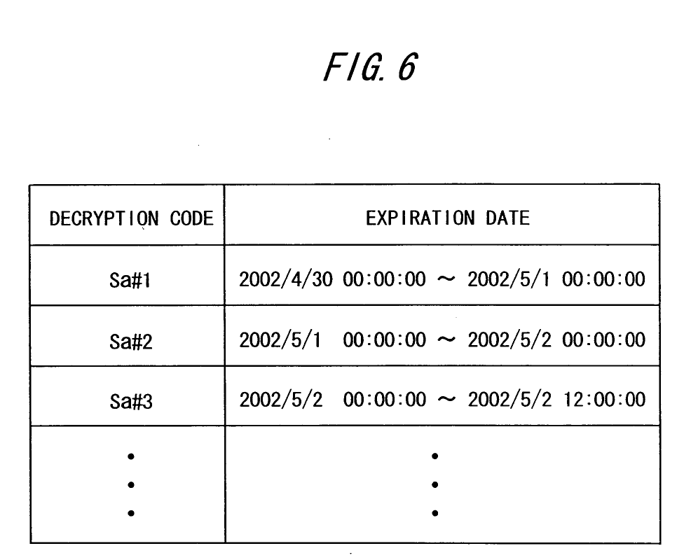

FIG. 6 is a diagram showing data (decryption information) stored in the decryption information storage section 9. The decryption information storage section 9 stores information to decrypt the data of the contents delivered by the local station 2. Concretely, the decryption information storage section 9 correlates and stores the decryption code and the decryption code expiration date. The decryption code is used by the decryption section 10 only for the decryption code expiration date.

Decryption Section

The decryption section 10 decrypts the data of the contents which is delivered by the local station 2 and received by the client 4. The decryption section 10 uses the decryption code stored in the decryption information storage section 9 to decrypt the data of the received contents. The decryption section 10 passes the data (plaintext data) of the decrypted contents to the display section 11.

Display Section

The display section 11 is configured by using a display such as a liquid crystal monitor, or a CRT (Cathode Ray Tub). Also, the display section 11 may be configured as needed by further using a sound output device such as a speaker, and a sound input device such as a microphone. The display section 11 outputs the plaintext data received from the broadcast receiving section 6.

Local Station

The configuration of the local station 2 will be described below. The local station 2 is configured by using the information processing apparatus having the communication function such as a personal computer or a workstation, or a dedicated apparatus. The local station 2 includes a CPU connected through a bus, a main memory (RAM), and an auxiliary storage (a hard disk, a flash memory, or the like), as hardware. The local station 2 functions as the apparatus including a Web server function execution section 12, an applet generation section 13, a source file storage section 14, an applet storage section 15, a publication destination information storage section 16, a viewer authentication section 17, an encryption information storage section 18, and an encryption section 19, when the various programs (OS, applications, and the like) stored in the auxiliary storage are loaded to the main memory and executed by the CPU. Also, the local station 2 has a communication apparatus (not shown). The Web server function execution section 12, the applet generation section 13, the source file storage section 14, the applet storage section 15, the publication destination information storage section 16, the viewer authentication section 17, the encryption information storage section 18, and the encryption section 19 use the communication apparatus to communicate with the client 4 or another apparatus through the network.

Web Browser Function Execution Section

The Web server function execution section 12 is attained when a program as the Web server (for example, HTTPD (Hypertext Transfer Protocol Daemon)) is executed by the CPU. The program to be executed may be a program as any Web server, for example, CERN Httpd or Apatch. The Web server function execution section 12 provides the functions as the Web server to the local station 2.

The Web server function execution section 12 publishes the broadcast receiving applet stored in the applet storage section 15 to the Internet. That is, the Web server function execution section 12 holds the broadcast receiving applet in a form of being downloadable through the Internet to unspecified users. The Web server function execution section 12 may be configured such that with the execution of a different program, a different protocol such as FTP (File Transfer Protocol) is used to publish the broadcast receiving applet. As examples of the different programs, there are FTPD (FTP Daemon) and the like.

Applet Generation Section

The applet generation section 13 uses a source file stored in the source file storage section 14 to generate a broad cast receiving applet. The applet generation section 13 is attained when a program for generating the broadcast applet is executed by the CPU.

The applet generation section 13 generates a client key set. The applet generation section 13 capsules and embeds the generated client key set in the broadcast receiving applet. The applet generation section 13 writes the generated broadcast receiving applet to the applet storage section 15.

Source File Storage Section

The source file storage section 14 is configured by using the auxiliary storage included in the local station 2. The source file storage section 14 stores a source code to generate the broadcast receiving applet, as a source file. The source file stored in the source file storage section 14 is read out by the applet generation section 13.

Applet Storage Section

The applet storage section 15 is configured by using the auxiliary storage, RAM, or the like included in the local station 2. The applet storage section 15 stores the broadcast receiving applet generated by the applet generation section 13. The broadcast receiving applet stored in the applet storage section 15 is published to the Internet by the Web server function execution section 12.

Publication destination Information Storage Section

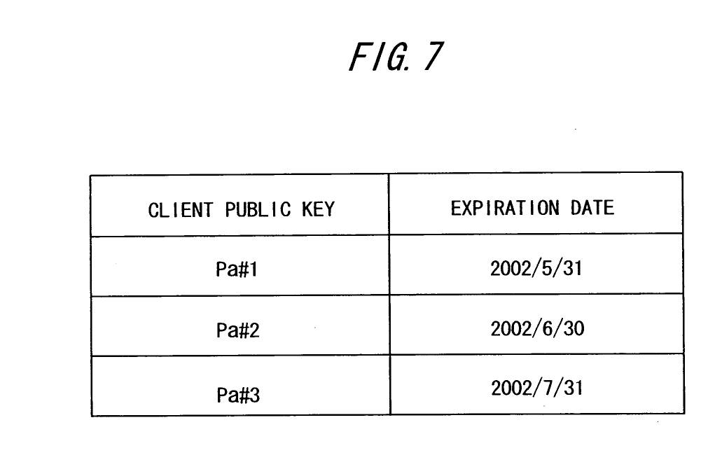

The publication destination information storage section 16 is configured by using the auxiliary storage, the RAM, or the like included in the local station 2. The publication destination information storage section 16 stores the publication destination information. FIG. 7 is a diagram showing an example of the publication destination information. The publication destination information has the client public key and an expiration date of each client public key while they are correlated. The publication destination information is written by the applet generation section 13.

Viewer Authentication Section

The viewer authentication section 17 is attained when a program to carry out the viewer authentication is executed by the CPU. The viewer authentication section 17 uses the client public key and client electronic sign, which are included in the decryption code request received from the client 4, to authenticate the client 4. If the client 4 is authenticated, the viewer authentication section 17 generates the decryption code response and transmits the generated decryption code response to the client 4. At this time, the viewer authentication section 17 encrypts the generated decryption code response by using the received client public key.

Encryption Information Storage Section

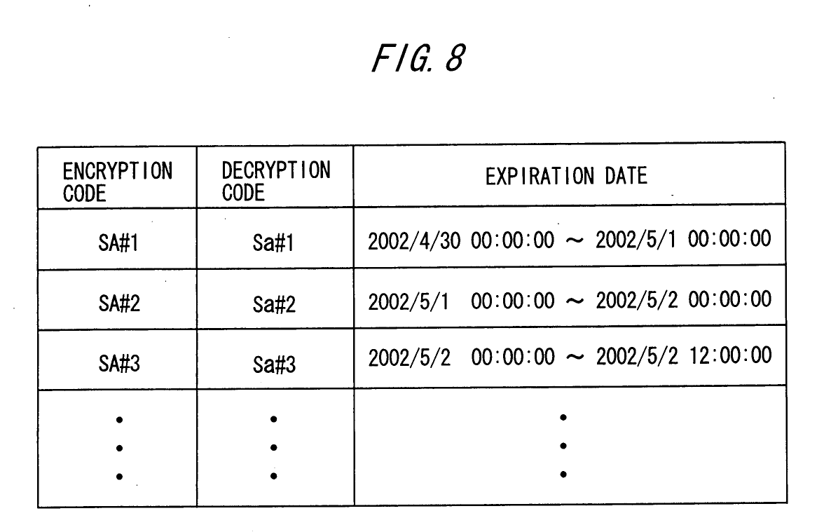

The encryption information storage section 18 is configured by using the auxiliary storage, the RAM, or the like included in the local station 2. FIG. 8 is a diagram showing an example of data (encryption information) stored in the encryption information storage section 18. The encryption information storage section 18 correlates and stores the encryption code, the decryption code, and the expiration date. The data encrypted in accordance with the encryption code can be decrypted in accordance with the correlated and stored decryption code. The encryption code is used for encrypting the data of the contents, for the corresponding expiration date.

Encryption Section

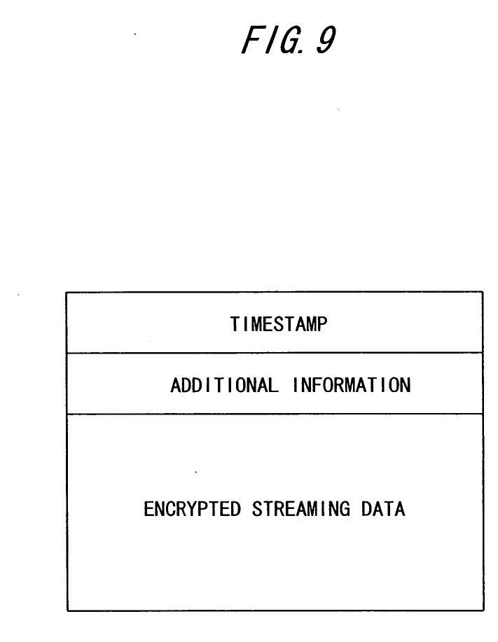

The encryption section 19 is attained when a program to encrypt the plaintext data of the streaming data is executed by the CPU. The encryption section 19 generates an encrypted data and transmits the generated encrypted data to the client 4. FIG. 9 is a diagram showing contents of the encrypted data. The encrypted data includes a timestamp, the additional information, and an encryption streaming data.

The encryption section 19 encrypts the plaintext data supplied by a supply section 20. The encryption section 19 uses the encryption code stored in the encryption information storage section 18, executes the encryption of the plaintext data, and generates the encryption streaming data. The encryption section 19 selects an effective encryption code in accordance with the corresponding expiration date, from the encryption codes, and uses the selected encryption code. The encryption streaming data generated by the encryption section 19 is transmitted together with the timestamp and additional information, as the encrypted data to the client 4.

Supply Section

The supply section 20 stores the plaintext data of the streaming data and passes the stored plaintext data to the local station 2. The plaintext data includes the data of the contents delivered to the client 4. The supply section 20 is included in, for example, the key station 3. The plaintext data stored in the supply section 20 is transmitted to the relay station 2a or local station 2, depending on the communication ability of the key station 3.

### OPERATION EXAMPLE

An operation example of the configuration of the broadcast system 1 will be described below. At first, an operation example of the client 4 is explained.

Client

The Web browser execution section 5 is operated as typical browser software. The display section 11 is operated as a typical output device. Also, the key storage section 8 and the decryption information storage section 9 are operated as the target from and to which the data is read and written. In this way, although those configurations have the characteristic parts in the stored contents of the data and the like, their operations are not the characteristic ones based on the present invention. For this reason, the detailed explanations with regard to the operation examples of the Web browser execution section 5, the key storage section 8, the decryption information storage section 9, and the display section 11 are omitted.

Decryption Code Obtainment Section

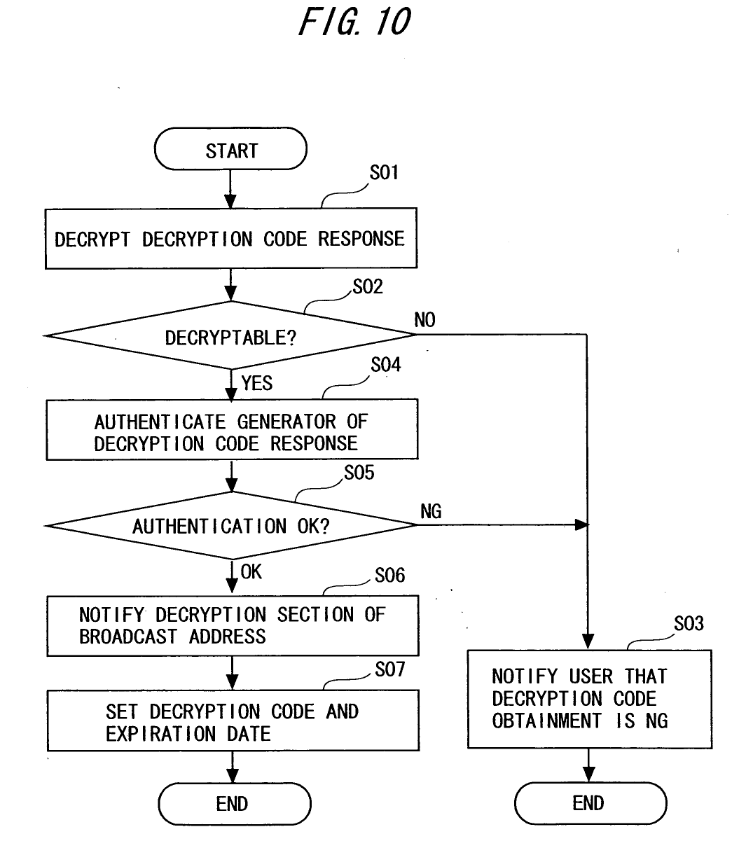

FIG. 10 is a flowchart showing an operation example of the decryption code obtainment section 7. FIG. 10 is used to explain the operation example of the decryption code obtainment section 7.

The decryption code obtainment section 7 decrypts the decryption code response received from the local station 2 by using the client secret key (S01). The decryption code obtainment section 7, if the decryption is failed (S02-No), reports the failure of the decryption code obtainment to the user (S03).

On the other hand, the decryption code obtainment section 7, if the decryption is successful (S02-Yes), uses the local station public key and authenticates a generator of the received decryption code response (S04). The decryption code obtainment section 7, if the authentication is failed (S05-NG), reports the failure of the decryption code obtainment to the user (S03).

On the other hand, the decryption code obtainment section 7, if the authentication is successful (S05-OK), reports the broadcast address included in the received decryption code response to the decryption section 10 (S06). Then, the decryption code obtainment section 7 sets the decryption code and decryption code expiration date, which are included in the received decryption code response, as the decryption information, in the decryption information storage section 9 (S07).

Decryption Section

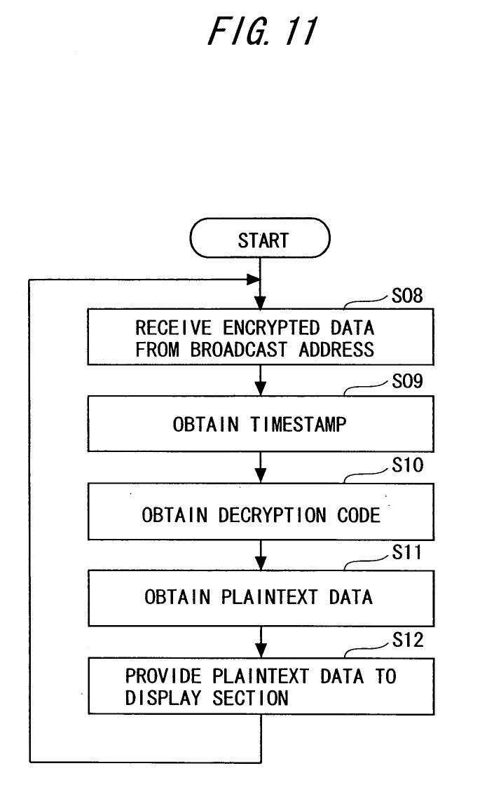

FIG. 11 is a flowchart showing an operation example of the decryption section 10. FIG. 11 is used to explain the operation example of the decryption section 10.

The decryption section 10 receives the encrypted data, from the broadcast address reported by the decryption code obtainment section 7 (S08). That is, the decryption section 10 receives the encrypted data transmitted to the multicast address included in the broadcast address. The decryption section 10 obtains the timestamp from the received encrypted data (S09). Next, the decryption section 10 uses the obtained timestamp as a key, retrieves the expiration date stored in the decryption information storage section 9, and obtains the corresponding decryption code. That is, the decryption section 10 obtains the decryption code that is effective at the date and time which are indicated by the obtained timestamp (S10). Next, the decryption section 10 uses the obtained decryption code, decrypts the encryption streaming data included in the received encrypted data, and obtains the plaintext data of the streaming data (S11). Then, the decryption section 10 passes the obtained plaintext data to the display section 11 (S12). In this way, the display section 11 displays the streaming data received from the local station 2.

Local Station

The operation example of the local station 2 will be described below. The Web server function execution section 12 is operated as a typical Web server. Also, the source file storage section 14, the applet storage section 15, the publication destination information storage section 16 and the encryption information storage section 18 are operated as the target from and to which the data is read and written. In this way, although those configurations have the characteristic parts in the stored contents of the data and the like, their operations are not the characteristic ones based on the present invention. For this reason, the detailed explanations with regard to the operation examples of the Web server function execution section 12, the source file storage section 14, the applet storage section 15, the publication destination information storage section 16, and the encryption information storage section 18 are omitted.

Applet Generation Section

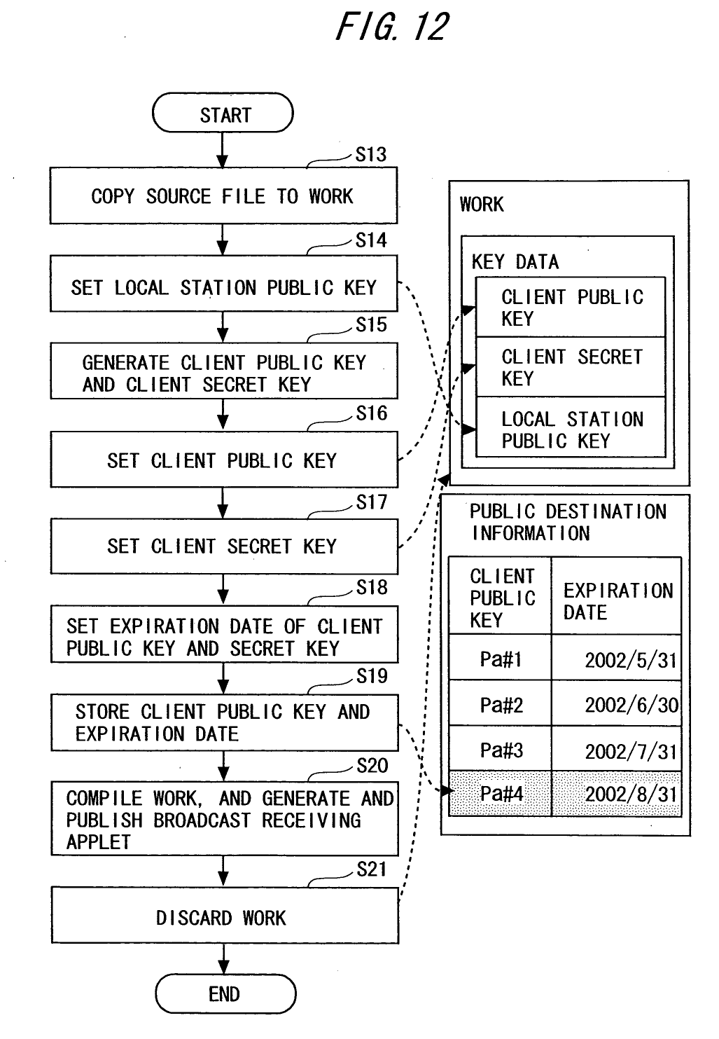

FIG. 12 is a flowchart showing an operation example of the applet generation section 13. FIG. 12 is used to explain the operation example of the applet generation section 13.

The applet generation section 13 is periodically actuated in response to the setting of the local station 2. The applet generation section 13, when actuated, generates the broadcast receiving applet in accordance with the flowchart shown in FIG. 12.

At first, the applet generation section 13 reserves a work region called a work on the memory region. The region where the client public key, the client secret key, and the local station public key are stored as the key data is generated inside the work. The applet generation section 13 copies the source file from the source file storage section 14 to the work (S13).

The applet generation section 13 sets the public key (local station public key) of the local station 2 preliminarily generated by the manager or the like of the local station 2, to the local station public key inside the work (S14). Next, the applet generation section 13 generates the key set of the client public key and the client secret key (S15). The applet generation section 13 sets the generated key set to the client public key and client secret key inside the work (S16, S17). Next, the applet generation section 13 sets the expiration date of the generated key set (S18). The applet generation section 13 correlates the generated client public key and expiration date and writes as the publication destination information to the publication destination information storage section 16 (S19).

The applet generation section 13 compiles the data inside the work and generates the broadcast receiving applet. The applet generation section 13 writes the generated broadcast receiving applet to the applet storage section 15 for the publication (S20) Then, the applet generation section 13 discards the work (S21).

Viewer Authentication Section

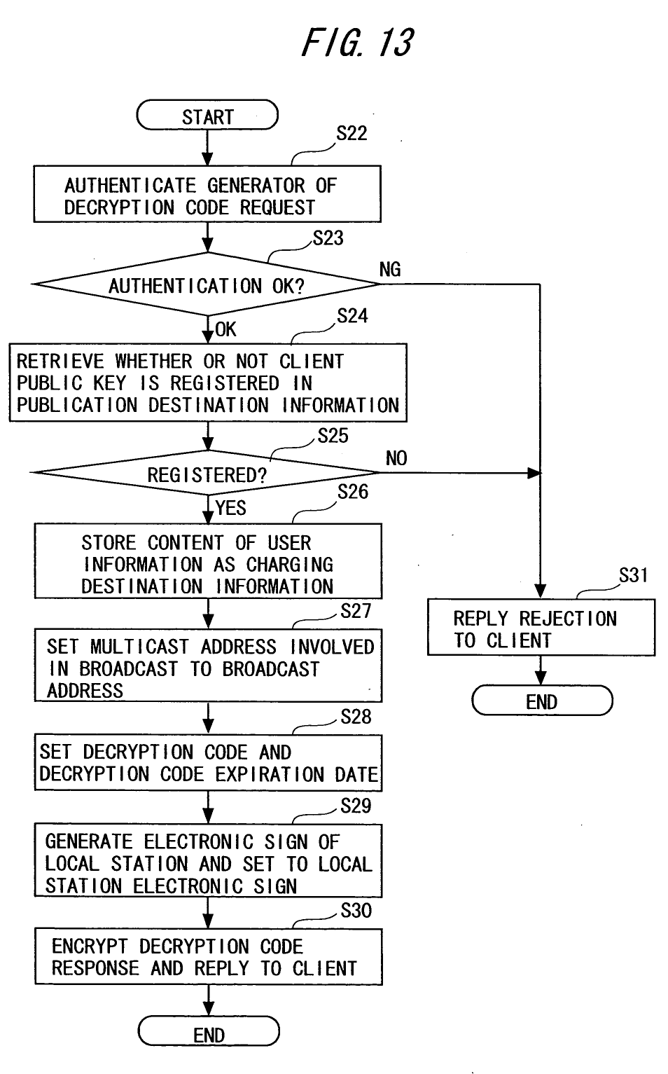

FIG. 13 is a flowchart showing an operation example of the viewer authentication section 17. FIG. 13 is used to explain the operation example of the viewer authentication section 17.

The viewer authentication section 17, when receiving the decryption code request, uses the client electronic sign included in the received decryption code request, and authenticates a generator of the received decryption code request (S22). The viewer authentication section 17, if the authentication is failed (S23-NG), replies the data indicating a rejection to the client 4 (S31).

On the other hand, the viewer authentication section 17, if the authentication is successful (S23-OK), retrieves whether or not the client public key included in the received decryption code request is registered in the publication destination information (S24). The viewer authentication section 17, if it is not registered (S25-No), replies the data indicating the rejection to the client 4 (S31).

On the other hand, the viewer authentication section 17, if it is registered (S25-Yes), stores the content of the user information included in the received decryption code request, as a charging destination information (S26). The collection of the charging to the user of the client 4 is executed by using this charging destination information. The collection of the charging may be executed by using any of existing methods.

The viewer authentication section 17 sets the multicast address of the content currently delivered by the local station 2, as the broadcast address of the decryption code response (S27). The viewer authentication section 17 sets the decryption code and expiration date, which are stored in the encryption information storage section 18, to the decryption code of the decryption code response and the decryption code expiration date (S28). At this time, the viewer authentication section 17 checks the expiration date with regard to the decryption codes to be stored in the encryption information storage section 18, and uses the decryption code and expiration date which can be used currently and/or in future, for the setting.

The viewer authentication section 17 uses the secret key (local station secret key) of the local station 2, generates the local station electronic sign. The viewer authentication section 17 sets the generated local station electronic sign to the local station electronic sign of the decryption code response (S29) At this time, the viewer authentication section 17 uses the local station secret key corresponding to the local station public key reported to the client 4 and generates the local station electronic sign. Then, the viewer authentication section 17 uses the client public key included in the received decryption code request, encrypts the decryption code response, and transmits it to the client 4 (S30).

Encryption Section

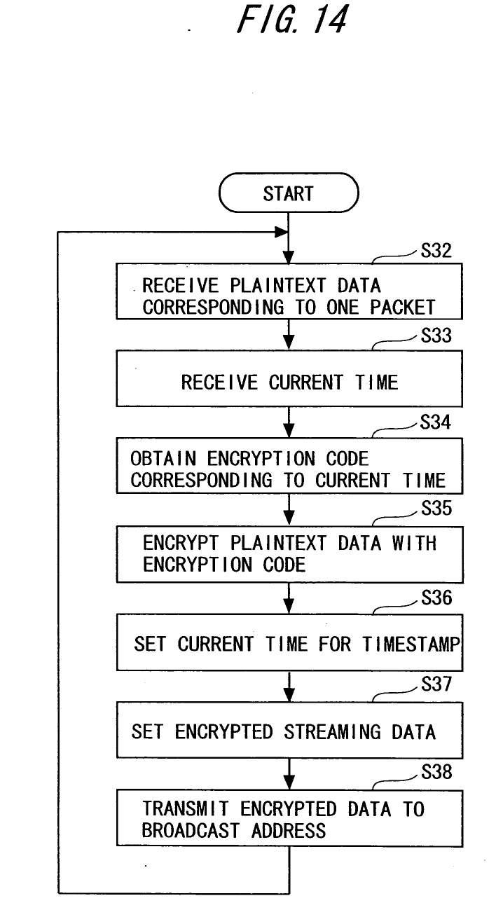

FIG. 14 is a flowchart showing an operation example of the encryption section 19. FIG. 14 is used to explain the operation example of the encryption section 19.

The encryption section 19 receives the plaintext data of the streaming data as the content from the supply section 20 (S32). At this time, the encryption section 19 receives the plaintext data of one packet sentence. Next, the encryption section 19 receives a current time from a timer section (not shown) of the local station 2 (S33). The encryption section 19 retrieves and obtains the encryption code whose expiration date corresponds to the received current time, from the encryption codes stored in the encryption information storage section 18 (S34). The encryption section 19 uses the obtained encryption code, encrypts the received plaintext data, and generates the encryption streaming data (S35). The encryption section 19 sets the received current time to the timestamp of the encrypted data (S36). Also, the encryption section 19 sets the generated encryption streaming data, as the encryption streaming data of the encrypted data (S37). Then, the encryption section 19 broadcasts (multicast transmits) the generated encrypted data to the broadcast address (S38).

[Operation Sequence]

Among the operation sequences of the broadcast system 1, the sequences of a receiving start process and a receiving continuation process will be described below.

Receiving Start Process

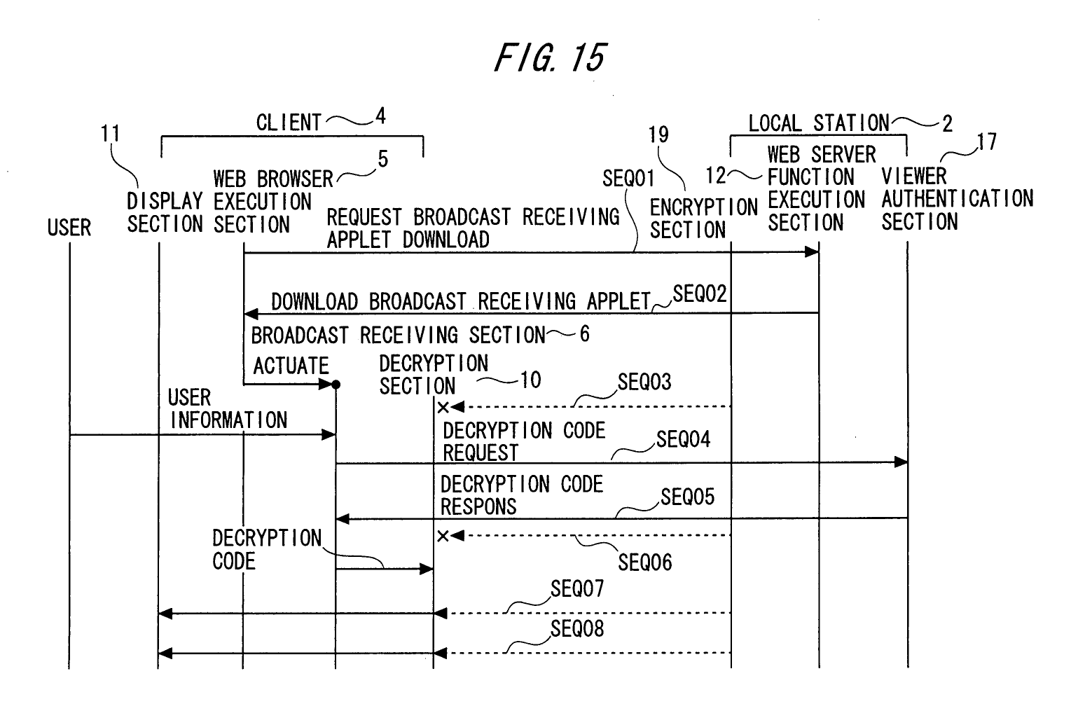

The receiving start process is the process executed when the client 4 starts receiving the content delivered by a certain local station 2. FIG. 15 is a diagram showing a sequence example of the receiving start process. FIG. 15 is used to explain the sequence example of the receiving start process.

At first, the Web browser execution section 5 of the client 4 transmits a broadcast receiving applet download request to the Web server function execution section 12 of the local station 2 (Seq01). That is, the client 4 requests the local station 2 to download the broadcast receiving applet. In response to this request, the Web server function execution section 12 executes the broadcast receiving applet download to the Web browser execution section 5 (Seq02). That is, from the local station 2 to the client 4, the broadcast receiving applet is downloaded. The downloaded broadcast receiving applet is executed by the Web browser execution section 5, thereby actuating the broadcast receiving section 6. At this time, since the broadcast receiving section 6 has not obtained the decryption code, the encrypted data delivered by the encryption section 19 of the local station 2 is not decrypted by the decryption section 10 (Seq03).

When the user inputs the user information, the decryption code obtainment section 7 of the broadcast receiving section 6 transmits the decryption code request to the local station 2 (Seq04). The viewer authentication section 17 of the local station 2 transmits the decryption code response to the client 4, with regard to the received decryption code request (Seq05) Even at this time, since the broadcast receiving section 6 has not obtained the decryption code, the encrypted data delivered by the encryption section 19 of the local station 2 is not decrypted by the decryption section 10 (Seq06).

The decryption code obtainment section 7 obtains the decryption code included in the received decryption code response, and writes the decryption code to the decryption information storage section 9, to thereby notify the decryption section 10 of the obtained decryption code. After that, the encrypted data delivered by the encryption section 19 of the local station 2 is decrypted by the decryption section 10, and the decrypted streaming data is outputted by the display section 11 (Seq07, Seq08).

Receiving Continuation Process

A receiving continuation process is a process executed when the client 4 continues to receive the content delivered by a certain local station 2. The encryption code and decryption code which are used by the local station 2 are changed in association with the elapse of a time. This change may be periodically executed or may be executed at any time depending on the convenience of the local station 2. In this way, the change of the encryption code and decryption code to be used can prevent the illegal viewer from carrying out the illegal viewing. In the receiving continuation process, in association with this change, a new decryption code is reported to the client 4, and the client 4 continues to receive the content in which the new decryption code is used.

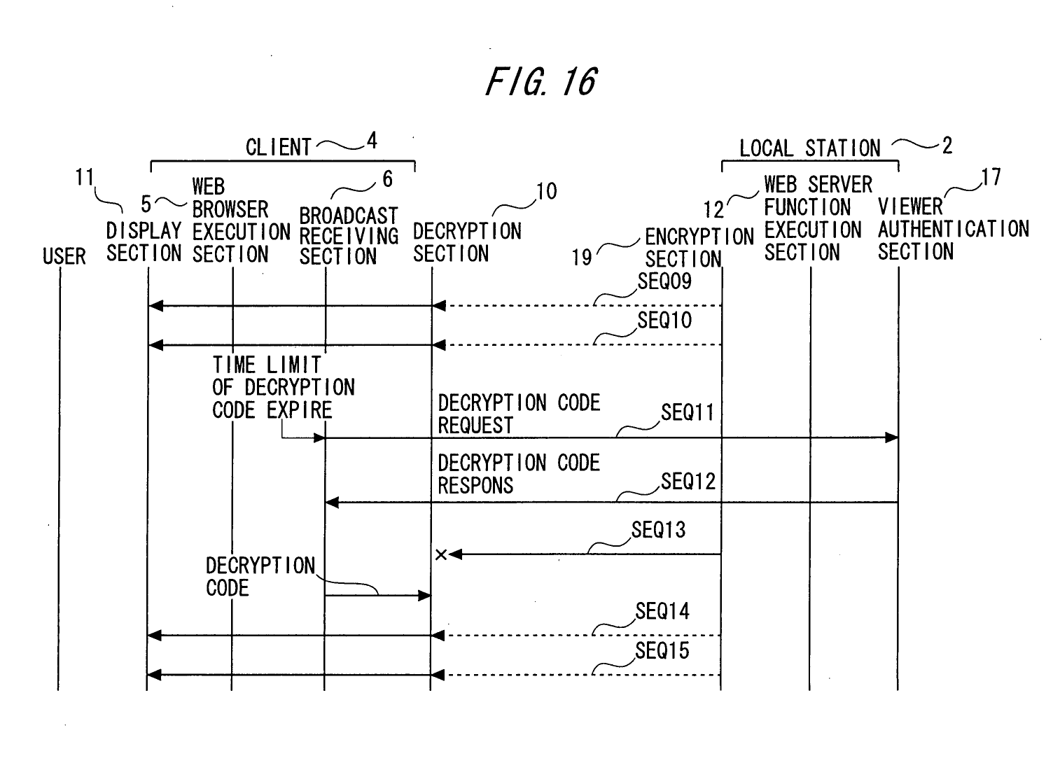

FIG. 16 is a diagram showing the sequence example of the receiving continuation process. FIG. 16 is used to explain the sequence example of the receiving continuation process.

Until the expiration of the expiration date of the decryption code used by the decryption section 10, the encrypted data transmitted by the encryption section 19 is decrypted by the decryption section 10 and outputted by the display section 11 (Seq09, Seq10). When the expiration date of the decryption code used by the decryption section 10 is expired, the decryption code obtainment section 7 of the broadcast receiving section 6 transmits the decryption code request to the local station 2, in order to obtain a new decryption code (Seq11). The viewer authentication section 17 of the local station 2 responds to the received decryption code request and transmits the decryption code response to the client 4 (Seq12). At this time, since the broadcast receiving section 6 has not obtained the new decryption code, an encrypted data to which the new encrypted data is applied by the encryption section 19 of the local station 2 is not decrypted by the decryption section 10 (Seq13).

The decryption code obtainment section 7 of the client 4 obtains the decryption code included in the received decryption code response and writes the decryption code to the decryption information storage section 9, to thereby notify the decryption section 10 of the obtained decryption code. After that, the encrypted data delivered by the encryption section 19 of the local station 2 is decrypted by the decryption section 10, and the decrypted streaming data is outputted by the display section 11, and the receiving is continued (Seq14, Seq15).

[Action/Effect]

In the first embodiment, the broadcast receiving applet in which the client key set and the local station public key are contained (embedded by the capsulation) is operated on the client 4. The broadcast receiving applet transmits the decryption code request including the electronic sign in order to obtain the decryption code. The local station 2 uses the electronic sign included in the decryption code request and authenticates the client 4 that is the transmission source of the decryption code request. At this time, the data of the key contained in the broadcast receiving applet used to generate this electronic sign is capsulated, which basically disables the user's reference. Thus, the viewer authentication section 17 of the local station 2 can discriminate between the illegally transmitted decryption code request without using the broadcast receiving applet and the legally transmitted decryption code request by using the broadcast receiving applet. Hence, since the decryption code is designed so as not to be transmitted to the illegal viewer who does not use the broadcast receiving applet, the illegal viewing can be prevented.

Also, the decryption code response including the decryption code is encrypted and transmitted so as to be able to be decrypted in accordance with the key contained in the broadcast receiving applet. As mentioned above, the data of the key contained in the broadcast receiving applet is capsulated, which basically disables the user's reference. For this reason, even if the illegal viewer illegally succeeds in obtaining the decryption code response, it is difficult to decrypt this decryption code response. Thus, in the first embodiment, it is possible to doubly prevent the illegal viewing together with the foregoing illegal viewing prevention measures. That is, unless the data of the key contained in the broadcast receiving applet is leaked, it is possible to prevent the illegal viewing of the broadcast.

Also, since the illegal viewing can be prevented as mentioned above, the data of the content can be delivered from the local station 2 to the client 4, through the multicast communication without using the unicast communication. Thus, the load on the communication process in the communication apparatus in the local station 2 and in the communication apparatus (relay) existing between the local station 2 and the client 4 is reduced.

Also, the user does not need to buy the special receiving apparatus and can view the broadcast by downloading the broadcast receiving applet through the Internet. Thus, the initial installation cost for the user can be reduced, which will stimulate demand.

Also, the update of the decryption code is attained by the decryption code request and decryption code response through the Internet. Thus, the update of the decryption code in the client 4 can be easily attained. Hence, the decryption code can be frequently updated, which enables the prevention of the occurrence of the illegal viewing caused by the continuous usage of the decryption code.

Also, the broadcast station for delivering the content through the local station 2 can collect the fee from the viewer in accordance with the user information included in the received decryption code request. Thus, the viewer can view anytime he/she wants, and pay the fee corresponding to the viewing time. Also, the broadcast station can arbitrarily set the fee for each content or viewing time, and charge the fee to the individual viewer on the basis of the viewing status of the content.

Also, the broadcast station can easily gather the viewing information, such as a viewing program and a viewing time, through the broadcast receiving applet.

### VARIATION EXAMPLE

In the broadcast system 1, the local station 2 is installed under the control of the relay station 2a. However, without any installation of the local station 2, the content distribution to the client 4 may be configured so as to be carried out by the relay station 2a and the key station 3. Also, in the broadcast system 1, the relay station 2a is installed under the control of the key station 3. However, without any installation of the relay station 2a, the content distribution to the client 4 may be configured so as to be carried out only by the key station. In this case, the key station 3 has the respective functions to carry out the content distribution to the client 4, similarly to the relay station 2a and the local station 2.

Also, in the Seq13 of the sequence example, the encrypted data which is not transiently decrypted by the decryption section 10 is induced owing to an update of the encryption code. However, the adjustment of the timing when the client 4 starts the receiving continuation process enables the decryption section 10 to seamlessly decrypt the received encrypted data. Specifically, a time necessary for the receiving continuation process is estimated, and the receiving continuation process may be started a given period in advance of a time point preceding the expiration date of the decryption code in use by the estimated time.

Also, in the first embodiment, the Internet is used to attain the broadcast system 1. However, independently of the Internet, if the two-way communication is possible between the broadcast side (the local station 2, the relay station 2a, and the key station 3) and the client 4, any different network may be used to attain the broadcast system 1. As examples of any different network, there are a BS digital broadcast and a ground wave digital broadcast.

Also, among the data of the key contained in the broadcast receiving applet, the client public key may be referred to by the user. That is, the broadcast receiving applet may be configured so as to make the client public key public. With this configuration, the user can confirm the content of the data to be transmitted to the local station 2 in accordance with the program of the broadcast receiving applet.

Also, the local station 2 in the first embodiment of the present invention may be divided into a plurality of functions and installed. For example, the installation of: a first server (corresponding to the publication apparatus) having the Web server function execution section 12, the applet generation section 13, the source file storage section 14, and the applet storage section 15; a second server (corresponding to the management apparatus) having the publication destination information storage section 16 and the viewer authentication section 17; and a third server (corresponding to the distribution apparatus) having the encryption information storage section 18 and the encryption section 19 may be configured to replace the local station 2.

### Second Embodiment

[System Configuration]

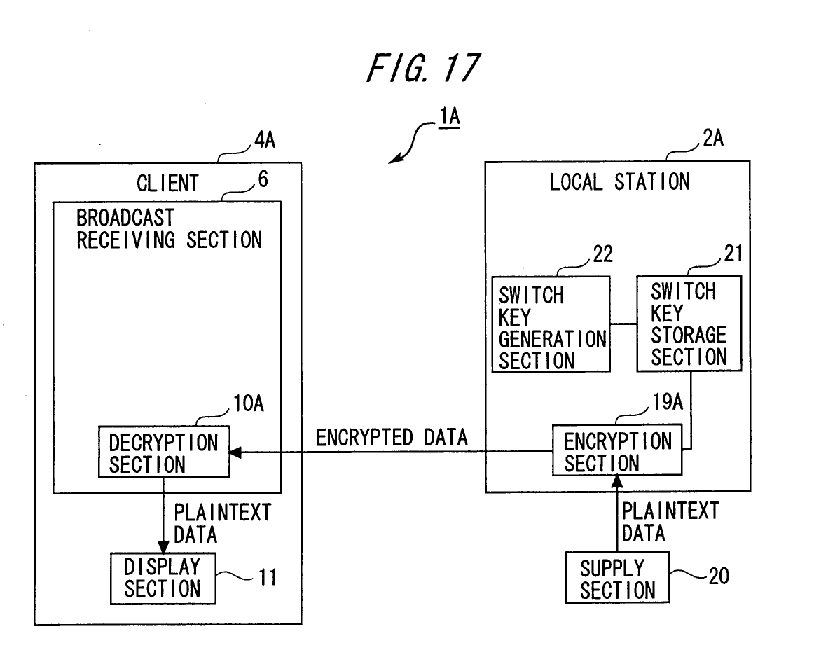

FIG. 17 is a diagram showing a schema of a broadcast system 1A according to a second embodiment of the present invention. In the broadcast system 1A, the client public key, the client secret key, the local station public key, and the local station secret key are arbitrarily switched to new keys (key switching process). FIG. 17 shows only a configuration required for explaining the key switching process. That is, a client 4A and a local station 2A shown in FIG. 17 have the configurations shown in FIG. 2, respectively, in addition to the configurations shown in FIG. 17. The broadcast system 1A will be described below by using FIG. 17.

Local Station

At first, the configuration of the local station 2A is explained. The local station 2A has an encryption section 19A, instead of the encryption section 19 in the local station 2. Also, the local station 2A has a switch key storage section 21 and a switch key generation section 22. Except for the foregoing points, the configuration of the local station 2A has the configuration similar to that of the local station 2.

Switch Key Storage Section

The switch key storage section 21 is configured by using the auxiliary storage in the local station 2A. The switch key storage section 21 stores a switch client key set table and a switch local station key set table.

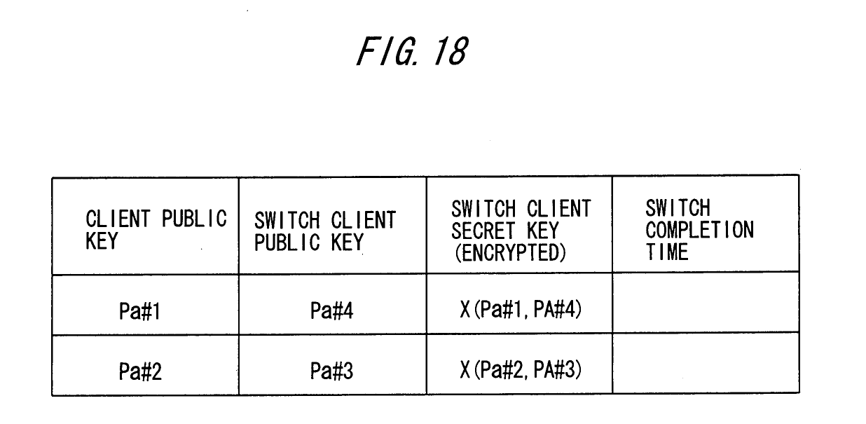

FIG. 18 is a diagram showing an example of the switch client key set table. FIG. 18 is used to explain the switch client key set table. Incidentally, hereafter, data “A” encrypted by a key of “Pa#1” is represented by “X(Pa#1, A)”.

The switch client key set table is used when the local station 2A changes the client key set (the client public key and the client secret key) used by the client 4A. The switch client key set table has: the client public key which is currently used by the client 4A and the local station 2A; the switch client key set (the switch client public key and the switch client secret key) to be used in future by the client 4A and the local station 2A (after the key switching process); and a switch completion time, in such a manner that the client public key, the switch client key set and a switch completion time are correlated with each other. The switch client key set table holds as the switch client secret key the data encrypted by the client public key.

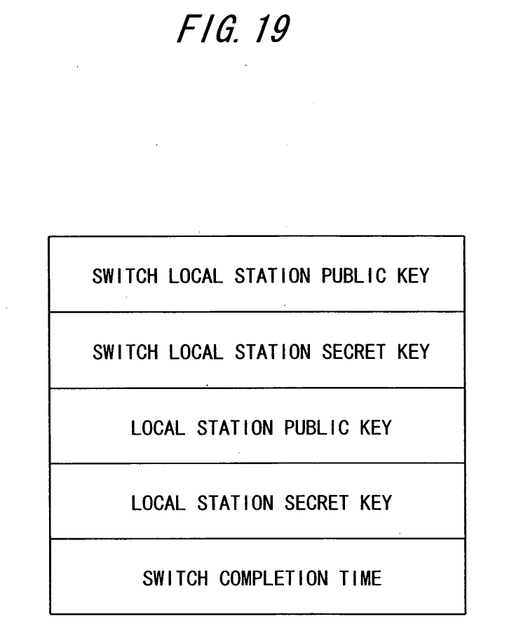

FIG. 19 is a diagram showing an example of the switch local station key set table. FIG. 19 is used to explain the switch local station key set table. The switch local station key set table has: the local station key set (the local station public key and the local station secret key) which is currently used by the client 4A and the local station 2A; the switch local station key set (the switch local station public key and the switch local station secret key) to be used in future by the client 4A and the local station 2A (after the key switching process); and the switch completion time, in such a manner that the client public key, the switch client key set and a switch completion time are correlated with each other.

The client key set and the local station key set are used until the corresponding switch completion time. After the switch completion time, the switch client key set and the switch local station key set are used.

Encryption Section

The encryption section 19A is different from the encryption section 19 included in the local station 2, in that the electronic sign is added to the encrypted data and that the key switching process is executed. Except the foregoing two points, the encryption section 19A has the same configuration as the encryption section 19 included in the local station 2.

The encryption section 19A uses the local station secret key to add the electronic sign to the encrypted data. With this electronic sign, the client 4 authenticates that the received encrypted data is the data which is encrypted and transmitted by the local station 2A.

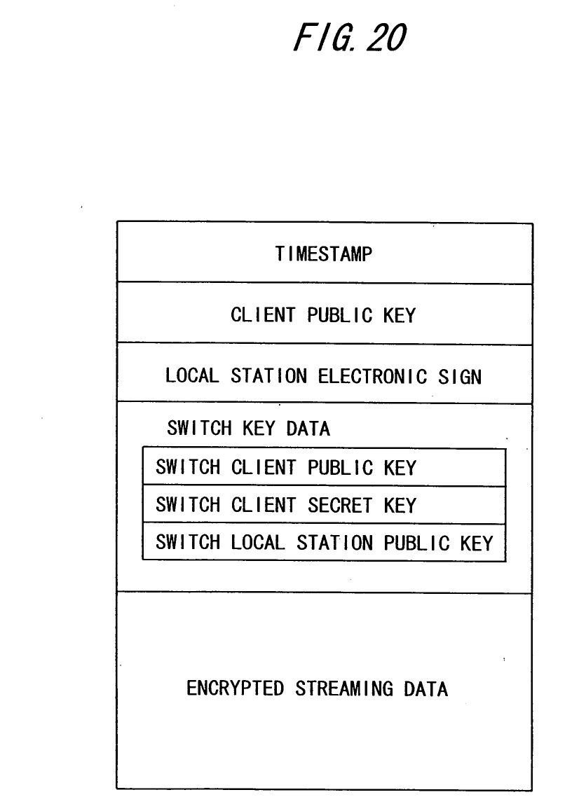

Also, the encryption section 19A executes the key switching process. FIG. 20 is a diagram showing the content of the encrypted data generated by the encryption section 19A at the time of the key switching process. The encryption section 19A, when executing the key switching process, adds the switch key data to the encrypted data. The switch key data includes the switch client public key, the switch client secret key, and the switch local station public key. The data of the key included in the switch key data is reported as the encrypted data to the client 4, and held and used in the client 4.

Switch Key Generation Section

The switch key generation section 22 is attained when a program for generating a new record in the switch client key set table and switch local key set table is executed by the CPU of the local station 2A. Here, the record in the switch client key set table indicates an entry (having the client public key, the switch client public key, the encrypted switch client secret key and the switch completion time in a correlated form) of the switch client key set table. Also, the record of the switch local station key set table indicates an entry having the switch local station key set, the local station key set, and the switch completion time in a correlated form.

The switch key generation section 22 selects any client public key stored in the publication destination information storage section 16. The switch key generation section 22 generates the record corresponding to the selected client public key. That is, the switch key generation section 22 generates the switch client key set corresponding to the selected client public key. Then, the switch key generation section 22 writes the generated record to the switch key storage section 21.

Also, the switch key generation section 22 generates a new local station key set. At this time, the switch key generation section 22 substitutes the switch local station public key and switch local station secret key, which are stored in the switch key storage section 21, for the local station public key and local station secret key. Then, the switch key generation section 22 sets the newly generated local station key set for the switch local station public key and switch local station secret key of the switch key storage section 21.

The operation of the switch key generation section 22 may be configured so as to be periodically executed or may be configured so as to be executed by considering the expiration date of each key.

Client

The configuration of the client 4A will be described below. The client 4A includes a decryption section 10A to replace the decryption section 10 in the client 4. Except for the foregoing points, the configuration of the client 4A is similar to that of the client 4.

Decryption Section

The decryption section 10A is different from the decryption section 10 in that the electronic sign is used to authenticate the encrypted data and that the key switching process is executed. The decryption section 10A, when the encrypted data is received from the local station 2A, authenticates a generator of the received encrypted data. The decryption section 10A carries out the authentication by using the local station electronic sign included in the received encrypted data and the local station public key stored in the key storage section 8 of the self apparatus 4.

Also, the decryption section 10A, when receiving the encrypted data including the switch key data from the local station 2, executes the key switching process. The decryption section 10A reflects the data of the received switch key data on the key storage section 8, at the time of the key switching process. In this case, the decryption section 10A substitutes the client public key, client secret key, and local station public key, which are stored in the key storage section 8, for the switch client public key, switch client secret key, and switch local station public key of the received switch key data.

### OPERATION EXAMPLE

An operation example of the configuration of the broadcast system 1A will be described below only with regard to the different points from the operation example in the broadcast system 1. At first, an operation example of the local station 2A is explained.

Local Station

The switch key storage section 21 is operated as the target from and to which the data is read and written. In this way, although the operation of the switch key storage section 21 has the characteristic parts in the memory content of the data and the like, its operation is not the characteristic part based on the present invention. Also, the configuration of the local station 2A is similar to that of the local station 2 except for the configuration of the switch key storage section 21, switch key generation section 22, and encryption section 19A. Thus, hereafter, only operation examples of the encryption section 19A and switch key generation section 22 are explained.

Decryption Section

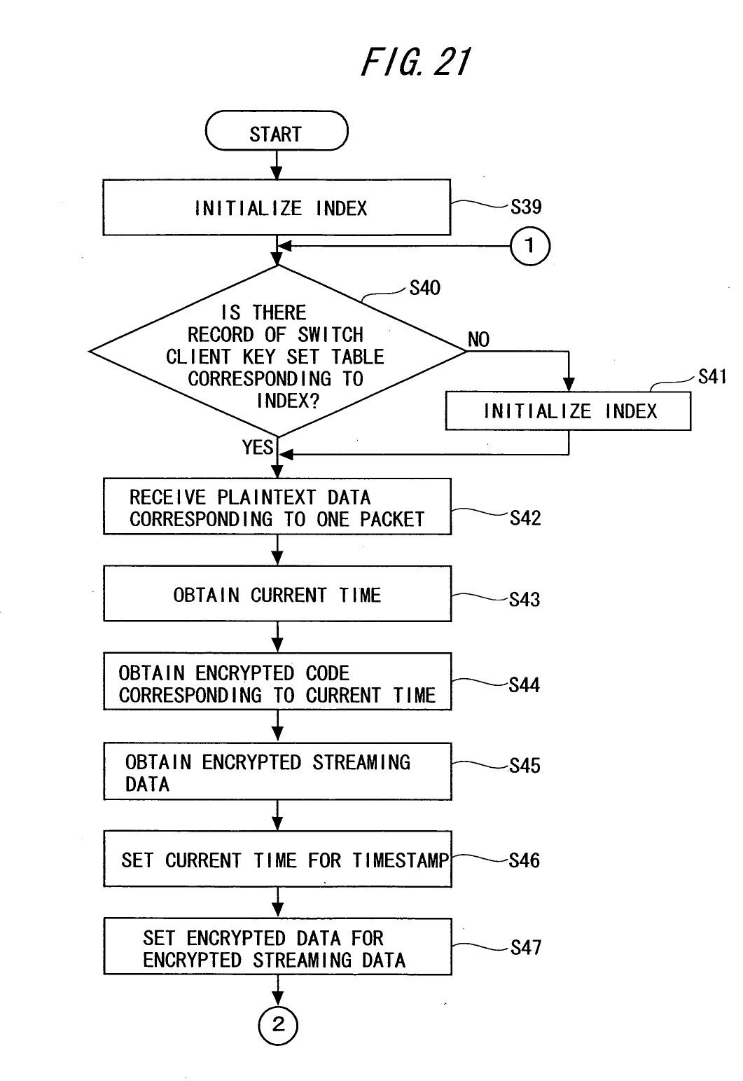

FIGS. 21 to 24 are flowcharts showing the operation examples of the encryption section 19A. FIGS. 21 to 24 are used to explain the operation examples of the encryption section 19A.

The encryption section 19A generates a variable referred to as an index, on the memory region, and initializes the index (S39: refer to FIG. 21). The concrete process for the initialization may be arbitrarily configured depending on the actual installation of the program. Here, as an example, the index is assumed to be the variable having any of integer values, and the initialization of the index is assumed to substitute 0 for the index.

The encryption section 19A examines the presence or absence of the record (entry) corresponding to the index, in the switch client key set table. If there is not the corresponding record (S40-No), the encryption section 19A initializes the index (S41). On the other hand, if there is the corresponding record (S40-Yes) or after the process of S41, the encryption section 19A receives the plaintext data corresponding to one packet from the supply section 20 (S42) Next, the encryption section 19A receives the current time from the timer section (not shown) of the local station 2A (S43). The encryption section 19A retrieves and obtains the encryption code whose expiration date corresponds to the received current time, from the encryption codes stored in the encryption information storage section 18 (S44). The encryption section 19A uses the obtained encryption code, encrypts the received plaintext data and generates the encryption streaming data (S45). The encryption section 19A sets the received current time for the timestamp of the encrypted data (S46). Also, the encryption section 19A sets the generated encryption streaming data, as the encryption streaming data of the encrypted data (S47).

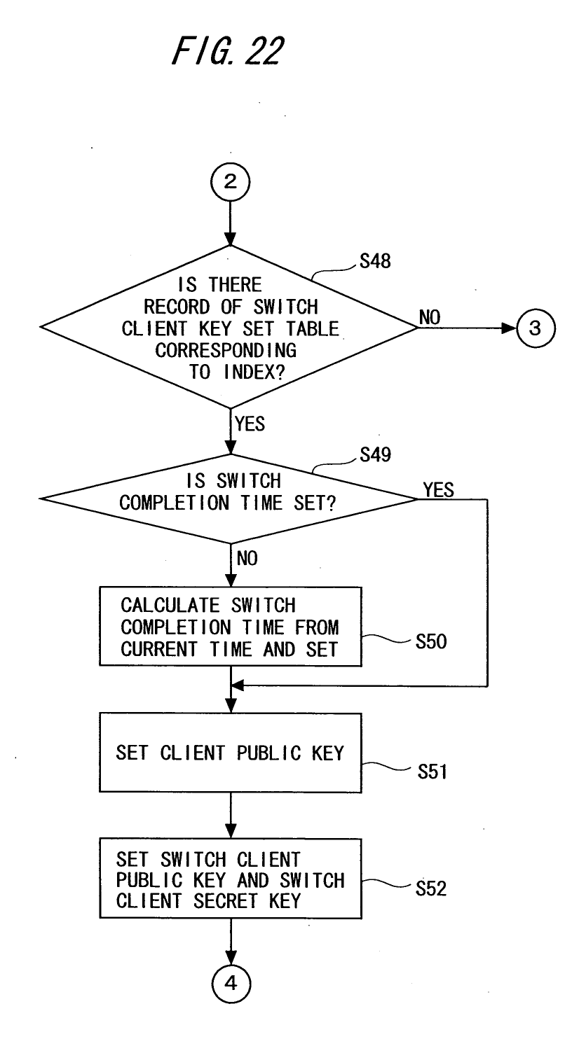

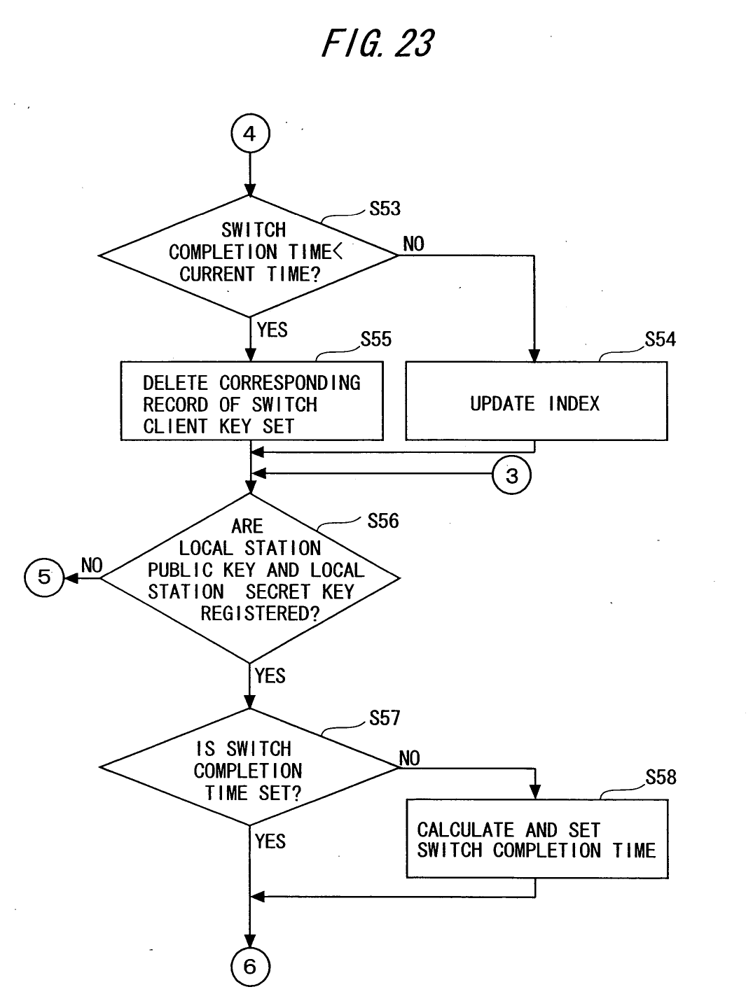

Then, the encryption section 19A examines the presence or absence of the record (entry) corresponding to the index, in the switch client key set table. If there is no corresponding record (S48-No: refer to FIG. 22), the encryption section 19A carries out the processes on and after S56 (refer to FIG. 23). These processes will be described later.

On the other hand, if there is the corresponding record (S48-Yes: refer to FIG. 22), the encryption section 19A examines whether or not the switch completion time is set with regard to the record corresponding to the index. If the switch completion time is not set (S49-No), the encryption section 19A uses the current time to calculate the switch completion time, and sets the calculated switch completion time (S50). Specifically, a time period (for example, several minutes) over which the key switching process is assumed to be completed in all of the clients 4A is added to the current time, thereby calculating the switch completion time. In other words, the decryption section 10A executes the key switching process during this additional period. On the other hand, if the switch completion time is set (S49-Yes) or after the process of S50, the encryption section 19A sets the client public key of the corresponding record, for the client public key of the encrypted data (S51). Also, the encryption section 19A sets the switch client public key and switch client secret key of the corresponding record, for the switch client public key and switch client secret key of the encrypted data (S52).

Next, the encryption section 19A compares the switch completion time of the corresponding record and the current time. If the switch completion time is ahead of the current time (S53-No: refer to FIG. 23), the encryption section 19A updates the index (S54). The update of the index is, specifically, to change the value of the index so that the index indicates a different record from the corresponding record in the switch client key set table. On the other hand, if the switch completion time is behind the current time (S53-Yes), the encryption section 19A deletes the corresponding record from the switch client key set table (S55).

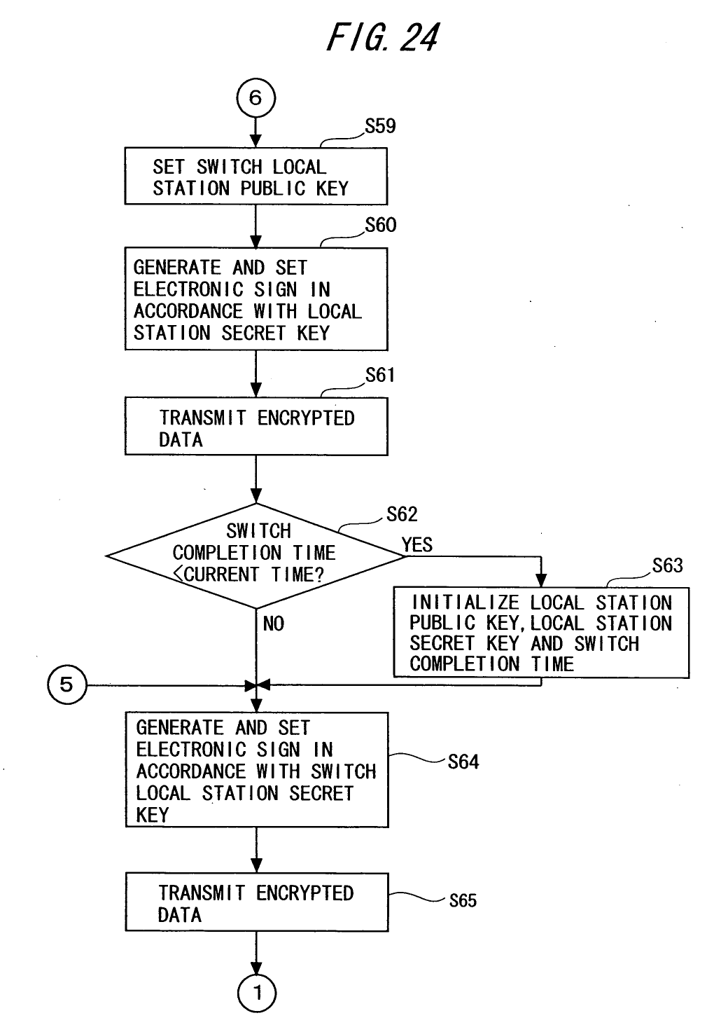

After the process of S54, or after the process of S55, or in the case of S48-No (refer to FIG. 22), the encryption section 19A confirms whether or not the local station public key and the local station secret key are registered in the switch local station key set table. If there is no registration (S56-No), the encryption section 19A executes the processes on and after S64 (refer to FIG. 24). These processes will be described later. On the other hand, if there is the registration (S56-Yes: refer to FIG. 23), the encryption section 19A confirms whether or not the switch completion time is set for the switch local station key set table. If the switch completion time is not set (S57-No), the encryption section 19A calculates and sets the switch completion time (S58). On the other hand, if the switch completion time is set (S57-Yes), or after the process of S55, the encryption section 19A sets the switch local station public key of the switch local station key set table, for the switch local station public key of the encrypted data (S59: refer to FIG. 24).

Next, the encryption section 19A uses the local station secret key of the switch local station key set table to add the electronic sign to the encrypted data (S60). Then, the encryption section 19A transmits the encrypted data to which the electronic sign is added, to the client 4A (S61).

Next, the encryption section 19A compares the switch completion time of the switch local station key set table with the current time. If the switch completion time is behind the current time (S62-Yes), the encryption section 19A initializes the local station public key, local station secret key, and switch completion time of the switch local station key set table (S63). Concretely, the encryption section 19A substitutes the value (for example, a zero value, NULL) indicating that the local station public key, the local station secret key, and the switch completion time are not set, for each value.

On the other hand, if the switch completion time is ahead of the current time (S62-No), or after the process of S63, or the case of S56-No (refer to FIG. 23), the encryption section 19A uses the switch local station secret key of the switch local station key set table to add the electronic sign to the encrypted data (S64). Here, the encrypted data to which the electronic sign is added is the data similar to the encrypted data transmitted at the process of S61, except for having the different electronic sign. Then, the encryption section 19A transmits the encrypted data to which the electronic sign is added, to the client 4A (S65) and executes the processes on and after S40 (refer to FIG. 21).

Switch Key Generation Section

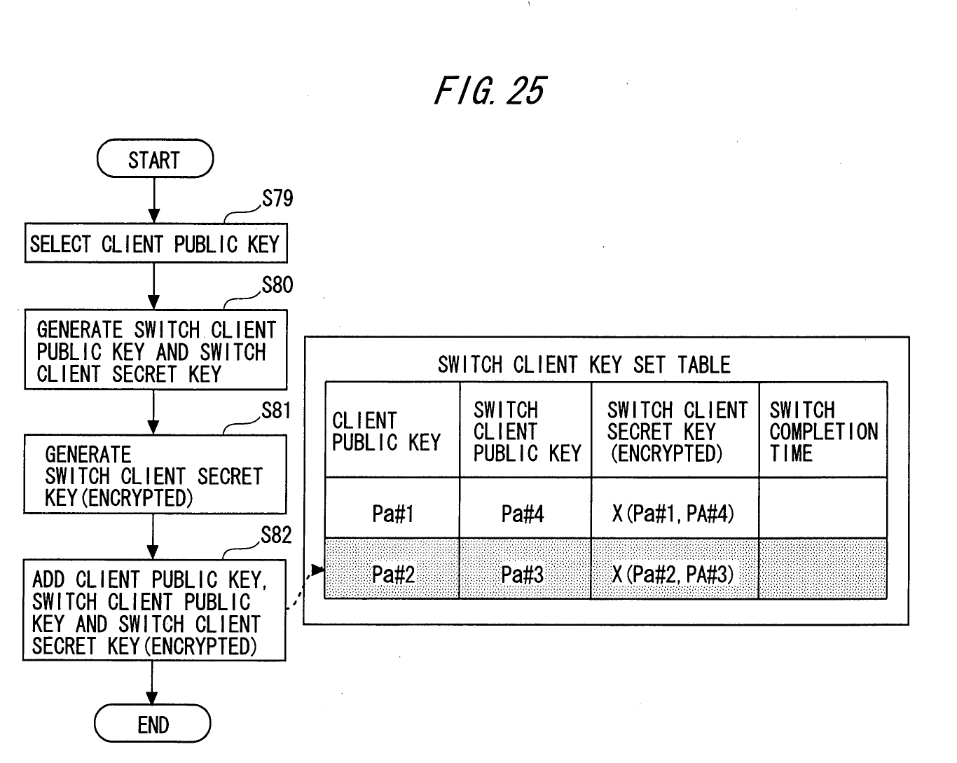

FIG. 25 is a flowchart showing the operation example of the switch key generation section 22. FIG. 25 is used to explain the operation example of the switch key generation section 22.

The switch key generation section 22 selects any client public key (for example: Pa#2) from the client public key stored in the publication destination information storage section 16 (S79). For example, the switch key generation section 22 selects the client public key whose expiration date is expiring (for example, several minutes until the expiration date).

Next, the switch key generation section 22 generates the switch client public key (for example: Pa#3) and the switch client secret key (for example: Pa#3) (S80). The switch key generation section 22 encrypts the generated switch client secret key by using the selected client public key (S81). Then, the switch key generation section 22 correlates the selected client public key, the generated switch client public key, and the encrypted switch client secret key (for example: X(Pa#2, Pa#3)), and writes those to the switch key storage section 21 (S82).

Client

The configuration except for the decryption section 10A of the client 4A is equal to the configuration of the client 4. Thus, only the operation example of the decryption section 10A will be described below.

Decryption Section

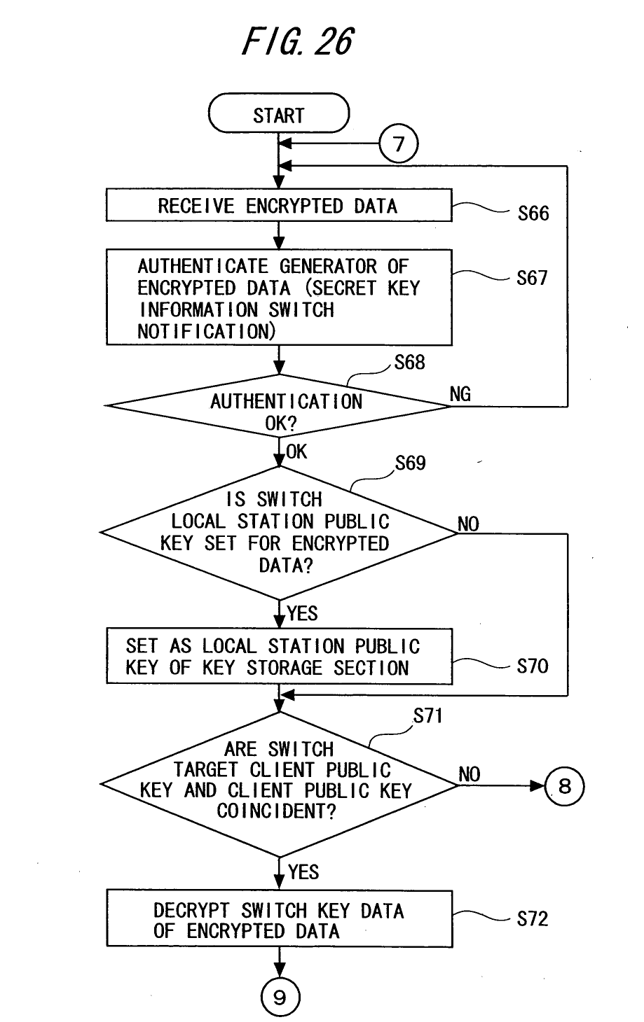

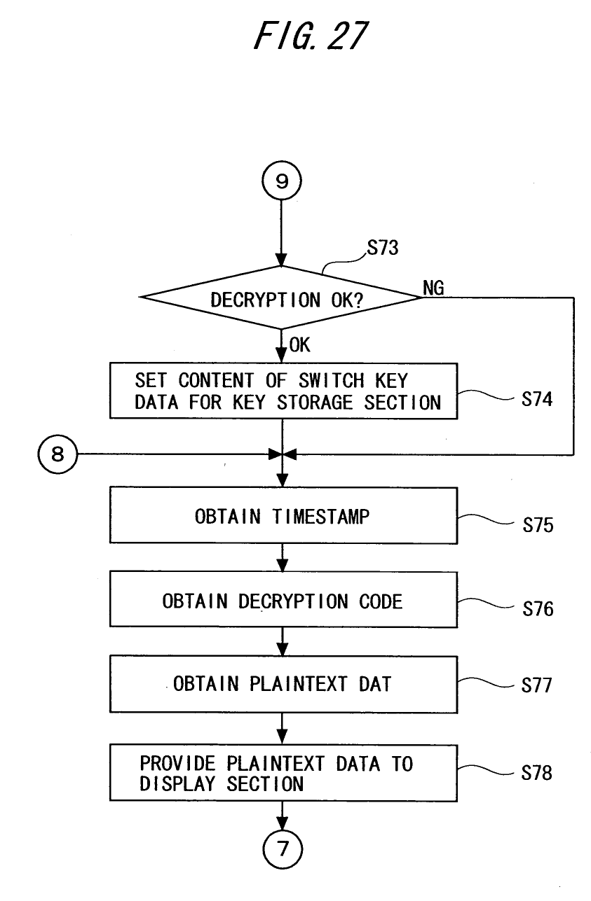

FIGS. 26 and 27 are flowcharts showing the operation example of the decryption section 10A. FIGS. 26 and 27 are used to explain the operation example of the decryption section 10A.

The decryption section 10A, when receiving the encrypted data (S66: refer to FIG. 26), uses the local station public key stored in the key storage section 8 to authenticate a generator of the encrypted data (S67). If the authentication is failed (S68-NG), the decryption section 10A returns to the process of S66. On the other hand, if the authentication is successful (S68-OK), the decryption section 10A confirms whether or not the switch local station public key is set for (included in) the received encrypted data. If the switch local station public key is set (S69-Yes), the decryption section 10A sets this switch local station public key, as the local station public key of the key storage section 8 of the client 4A (S70).

On the other hand, if the switch local station public key is not set for the encrypted data (S69-No), or after the process of S70, the decryption section 10A confirms whether or not the client public key included in the encrypted data and the client public key stored in the key storage section 8 of the client 4A are coincident. If they are not coincident (S71-No), the decryption section 10A executes the processes on and after S75 (refer to FIG. 27).

On the other hand, if they are coincident (S71-Yes: refer to FIG. 26), the decryption section 10A decrypts the switch key data stored in encrypted data by using the client secret key stored in the key storage section 8 of the client 4A (S72). The decryption section 10A carries out the processes on and after S75, if the decryption failed (S73-NG: refer to FIG. 27). On the other hand, if the decryption was successful (S73-OK), the decryption section 10A sets the content of the decrypted switch key data, for the key storage section 8 (S74). That is, the decryption section 10A sets the switch client public key, switch client secret key, and switch local station public key which are included in the decrypted switch key data, for the client public key, client secret key, and switch local station public key which are stored in the key storage section 8.

After the process of S74, or in the case of S73-NG, or in the case of S71-No (refer to FIG. 26), the decryption section 10A reads out and obtains the timestamp included in the encrypted data (S75). Next, the decryption section 10A defines the obtained timestamp as the key, retrieves the expiration date stored in the decryption information storage section 9 and obtains the corresponding decryption code. That is, the decryption section 10 obtains the decryption code that is effective on the date and time indicated by the obtained timestamp (S76). Next, the decryption section 10A uses the obtained decryption code to decrypt the encryption streaming data included in the received encrypted data and obtains the plaintext data of the streaming data (S77) Then, the decryption section 10A passes the obtained plaintext data to the display section 11 (S78). In this way, the display section 11 displays the streaming data received from the local station 2A. After the process of S78, the decryption section 10A executes the processes on and after S66.

[Operation Sequence]

Next, among the operation sequences of the broadcast system 1A, the process when the switch client key set and the switch local station key set are switched respectively is explained.

Case of Switch Client Key Set

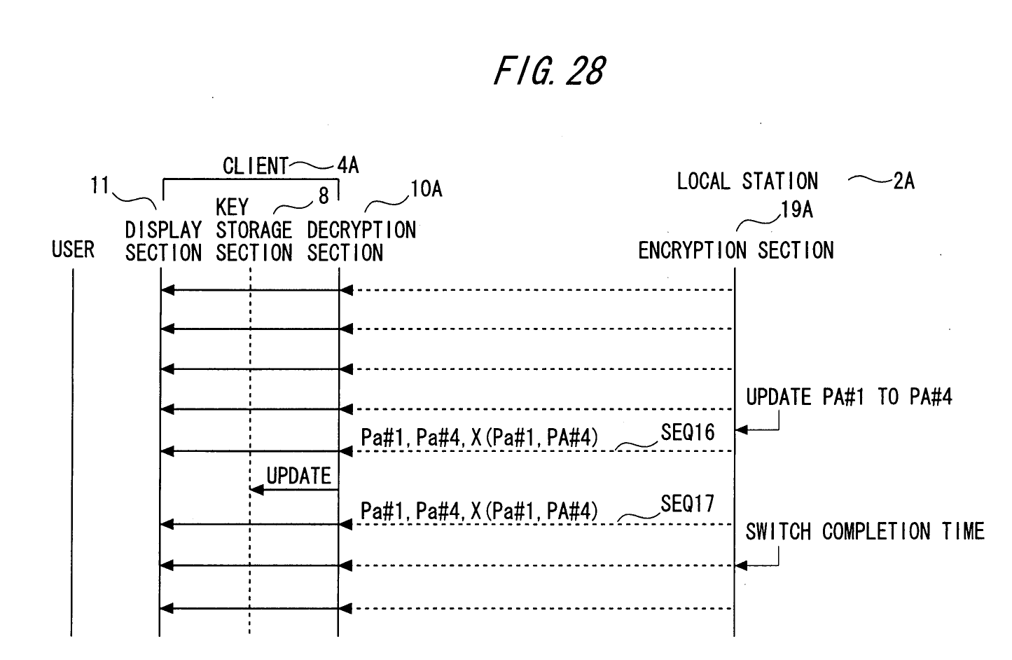

FIG. 28 is a sequence diagram showing the process when the switch client key set is switched. When the switch key generation section 22 registers a new record in the switch key storage section 21, the encryption section 19A transmits the encrypted data, to which the client public key (Pa#1), the switch client public key (Pa#4) and the switch client secret key (Pa#4) are added, to the client 4A (Seq16). The decryption section 10A of the client 4A, when this encrypted data is received, uses the added information to update the data of the key stored in the key storage section 8. Hereafter, for a certain time (until the switch completion time set for the switch client key set table), the foregoing encrypted data is transmitted (Seq17).

Case of Switch Local Station Key Set

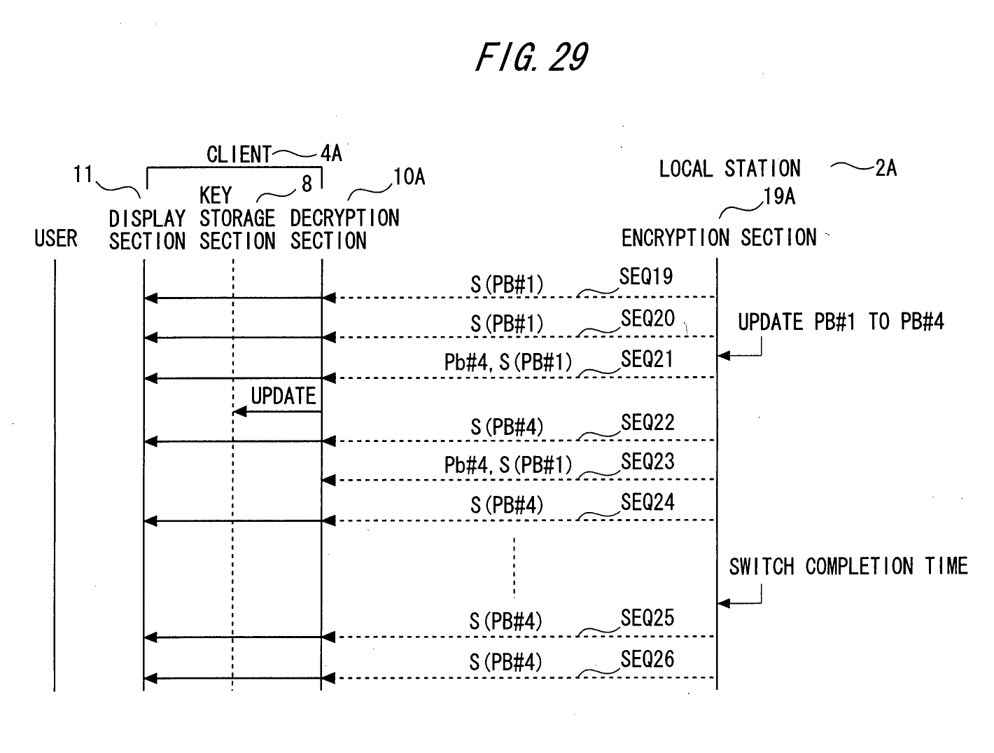

FIG. 29 is a sequence diagram showing the process when the switch local station key set is switched. The encryption section 19A, when transmitting the encrypted data, uses the local station secret key (PB#1) to add an electronic sign (S(PB#1)) (Seqs19, 20). When the switch key generation section 22 registers the new record in the switch key storage section 21, the encryption section 19A adds the newly generated switch local station public key (Pb#4) to the encrypted data and transmits the data (Seq21).

The decryption section 10A of the client 4A, when receiving the encrypted data to which the switch local station public key is added, uses the added switch local station public key to update the content of the key storage section 8.

After the new record is generated in the switch key storage section 21, the encrypted data to which the electronic sign (S(PB#4)) based on the switch local station secret key (PB#4) and the encrypted data to which the electronic sign based on the local station secret key (PB#1) and the switch local station public key (Pb#4) are added are transmitted to the encryption section 19A (Seqs 22, 23 and 24).

After the elapse of the switch completion time, the encryption section 19A transmits the encrypted data to which the electronic sign (S(PB#4)) based on the public key (PB#4) in the new record is added (Seqs 25, 26).

[Action/Effect]

In the second embodiment of the present invention, the switching between the client key set and the local station key set is executed. Typically, in the encryption key (the public key and the secret key), as the usage period becomes longer, the possibility of the leakage becomes higher. Thus, the execution of the switching between the client key set and the local station key set enables the prevention of the leakage.

Also, the report to the client 4A of the switch client key set and switch local station public key is carried out by using the current local station secret key. Thus, unless the current local station secret key is leaked, the leakage of the switch client key set and switch local station public key is prevented.

Also, the report to the client 4A of the switch client key set and switch local station public key is carried out as the encrypted data. That is, the encrypted data including the data of those keys is transmitted to the client 4A. Then, the decryption section 10A of the client 4A uses the data of those keys included in the encrypted data and updates the memory content of the key storage section 8. Thus, the user of the client 4A, if the key is updated, does not need to again download the broadcast receiving applet. Similarly, the user of the client 4A does not need to carry out the procedure for updating the key.

The disclosures of international application PCT/JP2003/001932 filed on Feb. 21, 2003 including the specification, drawings and abstract are incorporated herein by reference.

### INDUSTRIAL APPLICABILITY

The present invention can be applied to industries that provide services for delivering contents which need to be protected against illegal obtainment (for example, the content of the pay broadcast) to an unspecified large number of persons.

1. A distribution system, comprising:
a management apparatus including:
a receiving unit receiving a code request including an electronic sign generated in accordance with a first key data;
an authentication unit authenticating a transmission source of the code request by using a second key data corresponding to the first key data and the electronic sign;
a reply unit, when the authentication unit authenticates the transmission source, transmitting a code response which includes at least a decryption code and is encrypted in accordance with a third key data;
an encryption unit encrypting data of a content to be multicasted, by using an encryption code corresponding to the decryption code; and
a distribution unit multicasting the data encrypted by the encryption unit; and
a receiving apparatus including:
an addition unit adding the electronic sign to the code request by using the first key data;
a transmission unit transmitting the code request including the electronic sign generated by the addition unit;
a receiving unit receiving an encrypted data which is multicasted by the management apparatus and the code response which is transmitted by the management apparatus;
an obtainment unit decrypting and obtaining the decryption code included in the code response received by the receiving unit, by using a fourth key data corresponding to the third key data; and
a decryption unit decrypting the encrypted data received by the receiving unit by using the decryption code obtained by the obtainment unit, and passing a decrypted data to an output unit.

2. A distribution system, comprising:
a management apparatus including:
a receiving unit receiving a code request including an electronic sign generated in accordance with a first key data;
an authentication unit authenticating a transmission source of the code request by using a second key data corresponding to the first key data and the electronic sign;
a reply unit, when the authentication unit authenticates the transmission source, transmitting a code response which includes at least a decryption code and is encrypted in accordance with a third key data;
a distribution apparatus including:
an encryption unit encrypting data of a content to be multicasted, by using an encryption code corresponding to the decryption code; and
a distribution unit multicasting the data encrypted by the encryption unit; and
a receiving apparatus including:
an addition unit adding the electronic sign to the code request by using the first key data;
a transmission unit transmitting the code request including the electronic sign generated by the addition unit;
a receiving unit receiving an encrypted data which is multicasted by the distribution apparatus and the code response which is transmitted by the management apparatus;
an obtainment unit decrypting and obtaining the decryption code included in the code response received by the receiving unit, by using a fourth key data corresponding to the third key data; and
a decryption unit decrypting the encrypted data received by the receiving unit by using the decryption code obtained by the obtainment unit, and passing a decrypted data to an output unit.

3. The distribution system according to claim 1, wherein the first key data and the fourth key data are able to be referred to only by the addition unit and the obtainment unit.

4. The distribution system according to claim 2, wherein:
the addition unit, the obtainment unit, and the decryption unit are implemented on the receiving apparatus when a program is executed by the receiving apparatus; and
the distribution system further comprises a publication apparatus for publishing the program in a form of being downloadable by the receiving apparatus through a network.

5. The distribution system according to claim 1, wherein the first key data and the fourth key data are configured by using the same key data, and the second key data and the third key data are configured by using the same key data.

6. The distribution system according to claim 1, wherein:
the management apparatus further includes:
a key generation unit newly generating the first key data and the second key data; and
a key transmission unit transmitting the first key data generated by the key generation unit to the receiving apparatus; and
the authentication unit, after the key generation unit newly generates the second key data, uses the newly generated second key data.

7. The distribution system according to claim 6, wherein the addition unit of the receiving apparatus, after the new first key data is received from the management apparatus, uses the received new first key data.

8. The distribution system according to claim 1, wherein the addition unit of the receiving apparatus further adds an identification data to identify a user of its own apparatus, to the code request.

9. The distribution system according to claim 1, wherein:
the addition unit, the obtainment unit, and the decryption unit are implemented on the receiving apparatus when a program is executed by the receiving apparatus; and
the management apparatus further includes a publication unit for publishing the program in a form of being downloadable by the receiving apparatus through a network.

10. A management apparatus, comprising:
a receiving unit receiving a code request including an electronic sign generated in accordance with a first key data;
an authentication unit authenticating a transmission source of the code request by using a second key data corresponding to the first key data and the electronic sign;
a reply unit, when the authentication unit authenticates the transmission source, transmitting a code response which includes at least a decryption code and is encrypted in accordance with a third key data;
an encryption unit encrypting data of a content to be multicasted, by using an encryption code corresponding to the decryption code; and
a distribution unit multicasting the data encrypted by the encryption unit.

11. A receiving apparatus, comprising:
an addition unit adding an electronic sign to a code request by using a first key data corresponding to a second key data of a management apparatus which is a transmission destination of the code request;
a transmission unit transmitting the code request including the electronic sign generated by the addition unit;
a receiving unit receiving an encrypted data which is multicasted and the code response which is transmitted in response to the code request;
an obtainment unit decrypting and obtaining the decryption code, which is included in the code response received by the receiving unit and encrypted in accordance with a third key data, by using a fourth key data corresponding to the third key data; and
a decryption unit decrypting the encrypted data received by the receiving unit, by using the decryption code obtained by the obtainment unit and passing to an output unit.

12. The receiving apparatus according to claim 11, wherein the first key data and the fourth key data are able to be referred to only by the addition unit and the obtainment unit.

13. A program for controlling an information processing apparatus to execute:
adding an electronic sign to a code request by using a first key data corresponding to a second key data of a management apparatus which is a transmission destination of the code request;
transmitting the code request to which the electronic sign is added;
receiving the code response transmitted in response to the code request;
decrypting and obtaining the decryption code, which is included in the received code response and encrypted in accordance with a third key data, by using a fourth key data corresponding to the third key data;
receiving the encrypted data which is multicasted; and
decrypting the encrypted data which is received, by using the obtained decryption code, and passing to an output unit,
wherein the first key data, the fourth key data, and the decryption code are not able to be referred to by a user of the information processing apparatus and a different programs executed by the information processing apparatus.

14. The program according to claim 13, wherein the first key data and the fourth key data are provided.

15. The program according to claim 13, wherein the first key data and the fourth key data are configured by using the same key data, and the second key data and the third key data are configured by using the same key data.
